(19) United States
(12) Patent Application Publication
(10) Pub. No.: US 2026/0301363 A1
(43) Pub. Date: Oct. 1, 2026

(54) SERVERS, SYSTEMS, AND METHODS FOR MATCHING EXTRACTED DATA TO A DATA SOURCE

(71) Applicant: YouVersion, Inc., Edmond, OK (US)

(72) Inventors: Robert Lee Gruenewald, Edmond, OK (US); David Anthony Fedor, Edmond, OK (US); Timothy Todd Watson, Oklahoma CIty, OK (US); Brian Daniel Herbert, Edmond, OK (US)

(21) Appl. No.: 19/578,264

(22) Filed: Mar. 25, 2026

Related U.S. Application Data
(60) Provisional application No. 63/779,827, filed on Mar. 28, 2025.

(51) Int. Cl. G06V 10/74; G06T 3/4076; G06V 10/32

(52) U.S. Cl. CPC G06V 10/74; G06T 3/4076; G06V 10/32

(57) ABSTRACT

Systems and methods for matching a captured image of a page to a characteristic database are disclosed. In some embodiments, a system receives a captured image of a book page from a computing device and executes a corrective normalization process to generate a normalized output. The system executes a cascaded processing sequence that applies processing operations in order of increasing computational intensity, escalating to more computationally demanding operations when a prior processing level produces an insufficient confidence level. In some embodiments, a first-level processing sequence generates a numerical identifier from pixel data extracted from a low-resolution representation of the normalized output. In some embodiments, a second-level processing sequence extracts page characteristics and abstracts them into a vector representation. In some embodiments, a third-level processing sequence generates one or more advanced representations including optical character recognition.

### CROSS-REFERENCE TO RELATED APPLICATION

This application claims priority and benefit of U.S. Provisional Application No. 63/779,827, filed Mar. 28, 2025, the contents of which are incorporated herein by reference in its entirety.

### BACKGROUND

Books remain a primary medium through which readers engage with written content across a wide range of contexts, including education, religious study, professional reference, and recreational reading. Despite the proliferation of digital reading platforms and electronic content delivery systems, a substantial portion of reading activity continues to occur with physical printed materials, creating a persistent and unresolved gap between the physical reading experience and the digital tools and resources that readers increasingly expect to access alongside their reading activity.

A challenge associated with physical books is the difficulty of establishing a reliable and automated correspondence between a specific page of a specific physical book and its digital counterpart. Books exist in numerous editions, versions, translations, and formats, many of which share overlapping content while differing in layout, typography, physical dimensions, and stylistic characteristics. Identifying the exact edition and page of a physical book from a captured image presents significant technical challenges, as the captured image may reflect not only the content of the page but also artifacts introduced by the capture process itself, including variations in lighting, angle, focus, and physical condition of the page which can include hand-written notes.

Existing approaches to image-based content identification are not well suited to the specific characteristics of physical book pages. Book pages present a combination of textual, visual, and physical attributes that collectively distinguish one page from another, but no single attribute is reliably sufficient to make that distinction in all cases. Approaches that rely exclusively on text recognition are computationally intensive and may fail when image quality is insufficient to support accurate character recognition. Approaches that rely exclusively on visual pattern matching may fail when pages share similar layouts or when the captured image includes artifacts that obscure the underlying visual structure of the page.

The computational demands of image-based page identification present additional challenges. Processing a captured image through the most intensive available analysis operations for every captured image is resource-prohibitive, particularly in mobile device environments where processing power, memory, and battery capacity are constrained. At the same time, applying only the least intensive operations universally results in unacceptably low match accuracy for images that require more discriminating analysis to identify correctly. There is therefore a need for an approach that allocates computational resources efficiently based on the characteristics of the captured image and the confidence of intermediate results, avoiding unnecessary processing while ensuring that sufficient analysis is applied to achieve accurate matching.

Beyond the matching challenge, there is a broader unmet need for systems that bridge the physical and digital reading experiences in a meaningful and feature-rich way. Readers of physical books currently lack the ability to seamlessly access digital annotations, cross-references, translations, audio content, and supplemental resources tied to the specific page they are reading, without manual navigation of separate digital systems. The annotations and markings that readers add to physical books are similarly isolated from digital systems, with no automated mechanism for capturing, preserving, and synchronizing those annotations with the corresponding digital content.

Publishers and content rights holders face corresponding challenges in understanding how physical book content is being accessed and engaged with by readers, as the physical reading experience generates no usage data that can inform inventory decisions, marketing strategies, or content development. There is therefore a need for systems and methods that address the foregoing challenges by providing accurate, efficient, and scalable matching of physical book pages to their digital counterparts, while enabling a rich and integrated reading experience that bridges physical and digital formats and generates actionable insights for publishers and content rights holders.

### SUMMARY

The disclosure is directed to a system configured to process captured images of pages received from a user device and match the captured images to corresponding entries in a characteristic database. In some embodiments, the system is configured to execute a corrective normalization process on the captured images to generate a normalized output suitable for downstream processing. In some embodiments, the corrective normalization process is configured to address one or more of skew, white balance, blur, rotation, bleed-through, glare, and obstruction artifacts present in the captured image. In some embodiments, the system is configured to execute a cascaded processing sequence on the normalized output that applies processing operations in order of increasing computational intensity, escalating to more computationally demanding operations only when a prior processing level produces a confidence level that is insufficient to identify the captured page.

In some embodiments, the system is configured to execute a first-level processing sequence that generates a lower-resolution representation of the normalized output, extracts pixel data from the low-resolution representation, and reduces the extracted pixel data into a numerical identifier representing a lower-resolution fingerprint of the captured page for comparison against the characteristic database. In some embodiments, the system is configured to execute a second-level processing sequence upon receiving a first escalation signal, extracting one or more page characteristics from the normalized output and abstracting the one or more page characteristics into a vector representation for comparison against the characteristic database. In some embodiments, the one or more page characteristics include at least one of a structural characteristic, a typographic characteristic, a physical attribute characteristic, and a non-text visual element characteristic. In some embodiments, the system is configured to execute a third-level processing sequence upon receiving a second escalation signal, executing optical character recognition on the normalized output and generating one or more advanced representations including at least one of a text embedding vector, a global visual embedding, a set of local feature descriptors, and a spline analysis output, combining the one or more advanced representations into a composite match input for comparison against the characteristic database.

In some embodiments, the system is configured to maintain a characteristic database that stores unique identifiers and traits associated with a plurality of book pages to facilitate accurate matching. In some embodiments, the characteristic database is configured to store, per page entry, optical character recognition text, a text embedding vector, a global visual embedding, and a set of local feature descriptors, along with version, edition, and source metadata associated with each entry. In some embodiments, the system is configured to populate the characteristic database using multiple acquisition channels including publisher-supplied digital proofs, automated scanning pipelines, and crowdsourced capture workflows.

In some embodiments, the system is configured to handle scenarios where multiple candidate match entries satisfy a confidence threshold, presenting the candidate match entries to the user via a graphical user interface to enable user selection of the correct match. In some embodiments, the system is configured to leverage user interaction history to refine the matching process, prioritizing candidate entries associated with books and editions previously identified in the user's interaction history. In some embodiments, the system is configured to accept audio input from the user to supplement the matching process, enabling the user to verbally identify the book or edition to further constrain the candidate entries evaluated during matching.

In some embodiments, the system is configured to attribute a confirmed match result to the user, storing the confirmed match result in a user profile and enabling the system to recognize the matched book during subsequent user interactions. In some embodiments, the system is configured to compare the captured image against a clean version of the matched page stored in the characteristic database to identify user-added markings including highlights, handwritten notes, underlines, and other annotations. In some embodiments, the system is configured to recreate the identified annotations digitally within the digital version of the matched book, associating the annotations with the corresponding metadata for retrieval and cross-referencing.

In some embodiments, the system is configured to provide a plurality of user-facing application features based on the confirmed match result, including audio playback of the matched page content, display of alternate versions and translations of the matched text, multilingual text display, digital annotation synchronization, augmented reality overlays, and mapping features that link book content to real-world geographical locations. In some embodiments, the system is configured to provide audio playback using pre-recorded audio files or synthetic voice generation, assigning distinct voices to characters within the matched content to create an immersive audio experience. In some embodiments, the system is configured to gamify the reading experience by implementing leaderboards, reading challenges, and progress tracking based on the user's interaction with matched book content.

In some embodiments, the system is configured to generate companion content based on matched book pages using generative artificial intelligence, including summaries, page synopses, alternate reading level adaptations, and real-time visuals that illustrate key themes or events associated with the matched content. In some embodiments, the system is configured to dynamically reorder matched book content based on user preferences, such as chronological or thematic order, and to generate condensed versions of the matched content calibrated to a specified reading time. In some embodiments, the system is configured to enable print-on-demand services that allow users to generate physical copies of matched book content incorporating user-added annotations and personalized metadata.

In some embodiments, the system is configured to provide publishers with analytics and insights derived from user interactions with matched book content, including page usage statistics, geographical trends, reading behavior patterns, and intellectual property detection reporting. In some embodiments, the system is configured to identify trends in books scanned and purchased to support inventory regulation and market demand analysis. In some embodiments, the system is configured to provide users with personalized analytics including reading progress metrics, heat maps of frequently accessed content, and recommendations for related books based on the user's interaction history with matched book content.

In some embodiments, the system is configured to support accessibility features including dyslexia-friendly font rendering, text magnification, Braille page processing, and reading level adjustment to suit the user's age or education level. In some embodiments, the system is configured to support commercial features including real-time retail price display for matched books, purchase facilitation for related titles and accessories, digital preview of sealed books, and matching of scanned books to their corresponding audio versions for purchase or streaming. In some embodiments, the system is configured to enable virtual book club functionality, allowing participants to share reading progress, annotations, and discussion threads linked to specific pages of matched book content.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 shows a non-limiting example system architecture in accordance with some embodiments;

FIG. 2 illustrates various functionality which the system is configured to execute in accordance with some embodiments;

FIG. 3 shows additional features of the system that uses the matched results in accordance with some embodiments;

FIGS. 4 and 5 illustrate a user experience in relation to FIG. 3 in accordance with some embodiments;

FIG. 6 shows system generation processes in accordance with some embodiments;

FIG. 7 depicts an analytics process in accordance with some embodiments; and

FIG. 8 illustrates a computer system enabling or comprising the systems and methods in accordance with some embodiments.

### DETAILED DESCRIPTION

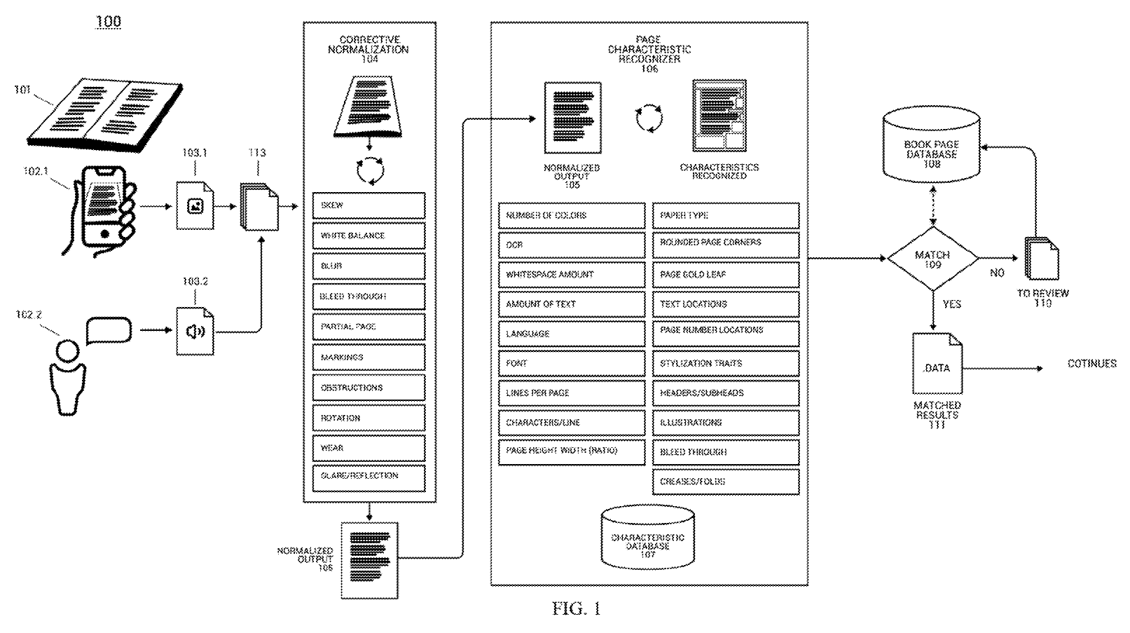

FIG. 1 shows a non-limiting example system architecture in accordance with some embodiments. As illustrated in process 100, in some embodiments, the system is configured to process images of printed books 101 to extract and normalize their content for further analysis and interaction. In some embodiments, the system is configured to allow users to capture images 103.1 of book pages using a mobile application or device camera 102.1. In some embodiments, the system is configured to capture a user’s input 102.2, such as an audio input 103.2, and associate the image and user input into a raw input file 113. In some embodiments, the system is configured to process the captured images either locally on the device or by sending them to a server for on premises or cloud-based processing. In some embodiments, the system is configured to operate on printed matter including bound or unbound books, magazines, pamphlets, brochures, leaflets, and similar periodicals, and is configured to treat each page of such printed matter as a page instance for normalization, indexing, and matching as described herein. For example, in some embodiments, the system is configured to enable a user to capture an image of a Bible page containing scripture and process it locally and/or in the cloud to prepare it for further analysis.

In some embodiments, the system is configured to execute a corrective normalization process 104 to generate a normalized output 105 of the captured images. In some embodiments, the system is configured to process pages displayed on non-paper surfaces including electronic ink displays, emissive or reflective monitors, projection screens, journaling pads, and large-format printed or illuminated media. In some embodiments, the system is configured to normalize moiré patterns, subpixel rendering artifacts, refresh-related banding, and display bezel occlusions when an image is captured from a screen or e-ink device, and is configured to treat the rendered layout as a page instance for indexing and matching. In some embodiments, the system is configured to process large-format media, including posters and billboards, by down-sampling the capture to generate a page-scale representation and by extracting global and/or local features sufficient to index and retrieve the corresponding source entry for the displayed content.

In some embodiments, the system is configured to perform the corrective normalization process 104 on scanned images and/or user input to ensure accurate processing and matching of book pages with or without user input. In some embodiments, the system is configured to correct skew in scanned images, aligning the text and layout to match the original or a desired page orientation. In some embodiments, the system is configured to adjust the white balance of the image, ensuring that the colors and brightness of the scanned page reflect the original document or a desired balance. In a non-limiting example, the system is configured to normalize the lighting of a Bible page scanned under uneven lighting conditions to enhance readability and matching accuracy.

In some embodiments, the system is configured to address blur in scanned images, sharpening the text and illustrations for improved recognition. In some embodiments, the system is configured to correct bleed-through, where text or images from the reverse side of a thin page interfere with the scanned content. In a non-limiting example, the system is configured to remove bleed-through artifacts from a scanned Bible page printed on delicate paper, ensuring the scripture text is clear and unobstructed, in accordance with some embodiments.

In some embodiments, the system is configured to handle partial page captures by identifying incomplete scans and/or reconstructing missing portions. In some embodiments, the system is configured to match partial-page imagery captured by a localized sensor that observes a sub-region of a page. In some embodiments, the system is configured to compute a region-level global embedding from the partial crop, retrieve candidate pages using embedding similarity, and refine the selection using local keypoint descriptor matches with geometric constraints. In some embodiments, the system is configured to fuse gesture or pointer data with the partial image by projecting the detected pointer location into the candidate page coordinate system to constrain the search to a local neighborhood covering one or more text lines or sentences. In some embodiments, the system is configured to compensate for perspective distortion, rolling shutter, and partial occlusions by estimating a homography between the captured crop and the candidate page, improving match confidence and enabling sentence-granular selection on partial captures. In some embodiments, the system is configured to remove markings, such as handwritten notes or highlights, from the scanned image to create a clean version for matching purposes. In some embodiments, the system is configured to address obstructions, such as fingers or objects partially covering the page, ensuring the scanned content is fully visible. For example, the system is configured to detect and remove obstructions from a scanned image of a religious document, preserving the integrity of the scripture text. In some embodiments, handwritten notes and highlights can be captured and flagged as desired.

In some embodiments, the system is configured to correct rotation in scanned images, ensuring the page is properly aligned for processing. In some embodiments, the system is configured to address wear and tear on the scanned page, such as creases or folds, by digitally reconstructing the damaged areas. In some embodiments, the system is configured to reduce glare or reflection caused by shiny surfaces, such as gold-leafed edges on a Bible page, to improve the quality of the scanned image. In a non-limiting example, the system is configured to eliminate glare from a scripture page scanned under direct lighting, ensuring the text is legible and accurately processed.

In some embodiments, the normalized output is used for further processing. In some embodiments, the system is configured to match the normalized page characteristics to a pre-existing database of book or other document source pages. In some embodiments, the database is configured to include pages derived from various sources, such as user-provided images, publisher print files, or other clean and pre-processed documents. In some embodiments, the system is configured to ingest source pages using multiple acquisition channels to increase database coverage and matching reliability. In some embodiments, the system is configured to ingest digital proofs supplied by publishers and printers, where page images are derived from pre-press files and normalized using the corrective normalization process 104. In some embodiments, the system is configured to ingest pages captured by automated scanning pipelines that batch process bound volumes into dewarped, glare-reduced, page-segmented images suitable for feature extraction and embedding generation. In some embodiments, the system is configured to ingest pages contributed by a crowd-sourced capture workflow, where user devices provide photographed pages that are queued for asynchronous normalization, de-duplication, and page-to-edition reconciliation prior to index insertion. For example, in some embodiments, the system is configured to compare captured text to clean, print-ready files of texts, such as religious text, to ensure accurate matching. In some embodiments, the system is configured to identify unique patterns and characteristics of the page to create a collective identifier for matching purposes.

As a non-limiting example, in some embodiments, the system is configured execute a page and/or character recognition process 106. In some embodiments, the system is configured to analyze the number of colors present on the scanned page to distinguish between different editions or versions of the same book. For example, the system is configured to recognize vibrant illustrations in a children’s Bible and use the color palette as a distinguishing feature for matching. In some embodiments, the system is configured to perform Optical Character Recognition (OCR) to extract text from the scanned page for processing and matching. In a non-limiting example, the system is configured to use OCR to identify scripture text, such as passages from the Book of Genesis, and match it to the correct version of the Bible in one or more databases.

In some embodiments, the system is configured to evaluate the amount of whitespace on the page to create a unique identifier for the scanned content. In some embodiments, the system is configured to analyze the amount of text present on the page to refine the matching process. For example, the system is configured to recognize the dense text layout of a study Bible and use this characteristic to identify the correct edition. In some embodiments, the system is configured to detect the language of the text to narrow down potential matches in the database. In a non-limiting example, the system is configured to identify Greek text in a scanned page of the New Testament and match it to the corresponding entry.

In some embodiments, the system is configured to analyze the font style and size used on the page to create one or more unique identifiers for the scanned content. In some embodiments, the system is configured to evaluate the number of lines per page to distinguish between different editions or formats of the same book. For example, the system is configured to recognize the compact layout of a pocket-sized Bible and use this characteristic to refine the matching process. In some embodiments, the system is configured to analyze the number of characters per line to further enhance the accuracy of page recognition.

In some embodiments, the system is configured to evaluate the page height-to-width ratio to identify physical dimensions that distinguish one book from another. In some embodiments, the system is configured to analyze the paper type, such as glossy or matte finishes, to refine the matching process. For example, the system is configured to recognize the glossy pages of a Bible with illustrations and use this trait to identify the correct version. In some embodiments, the system is configured to detect rounded or other shaped page corners or other characteristics to identify distinguishing features of the scanned page.

In some embodiments, the system is configured to analyze the presence of patterns other than text on the page to create a distinctive fingerprint (a unique identifier) for matching purposes. For example, the system is configured to recognize the gold-leafed edges of a Bible page and use this characteristic to match the page to its corresponding entry in the database. In some embodiments, the system is configured to detect text locations on the page, such as headers or verse numbers, to improve the accuracy of page recognition. In a non-limiting example, the system is configured to identify the location of chapter headers in a scanned page from the Book of Isaiah and use this information for matching.

In some embodiments, the system is configured to evaluate page number locations to ensure precise and accurate identification of scanned pages. In some embodiments, the system is configured to analyze stylization traits, such as decorative borders or other unique or unusual formatting, to refine the matching process. For example, in some embodiments, the system is configured to detect ornate borders on a scanned Bible page and use this feature to identify the correct edition. In some embodiments, the system is configured to detect headers and sub headers to distinguish between different sections and/or versions of the book.

In some embodiments, the system is configured to analyze illustrations present on the page to create a comprehensive fingerprint of the scanned content. For example, in some embodiments, the system is configured to detect illustrations accompanying scripture text in a children’s Bible and use these features to refine the matching process. In some embodiments, the system is configured to evaluate bleed-through effects caused by text or images from the reverse side of the page to ensure accurate recognition. In a non-limiting example, the system is configured to remove bleed-through and any other artifacts from a scanned page of the Book of Revelation printed on delicate paper.

In some embodiments, the system is configured to analyze creases and folds on the page to account for physical characteristics that may impact recognition. For example, the system is configured to digitally reconstruct a scanned Bible page that has visible creases to delete the creases to ensure the text is clear and accurately processed.

In some embodiments, the system is configured to maintain a characteristic database 107 that stores unique identifiers and traits associated with book pages to facilitate accurate matching. In some embodiments, the characteristic database 107 functions as a page index database configured to store multi-modal data for each reference page. In some embodiments, the system is configured to store, per page entry, (i) optical character recognition text, (ii) a text embedding vector derived from the recognized text, (iii) a global visual embedding that summarizes page-level layout, typography, and whitespace structure, and (iv) a set of local feature descriptors associated with keypoints distributed over the page image. In some embodiments, the system is configured to use the global visual embedding to rapidly shortlist candidate entries and to use the local feature descriptors to produce a match score via descriptor-space nearest-neighbor comparisons with geometric consistency checks. In some embodiments, the system is configured to persist version, edition, and source metadata with each entry in a database to distinguish between similar layouts and to improve subsequent user attribution, recommendations, and synchronization behaviors. In some embodiments, the system is configured to populate the database with detailed characteristics derived from scanned pages, including text layout, stylistic traits, and physical attributes. For example, the system is configured to store the layout of scripture passages from a religious document, including the positioning of chapter headers and verse numbers, to ensure precise and accurate identification during future scans.

In some embodiments, the system is configured to include metadata in the characteristic database, such as the language of the text, font styles, and page dimensions, to refine the matching process. In some embodiments, the system is configured to store, for each page entry in the characteristic database 107, a canonical reference image path or persistent identifier corresponding to a normalized page image used during feature extraction and embedding generation. In some embodiments, the system is configured to associate the canonical reference image with the page’s text embedding, global visual embedding, and local feature descriptors to enable deterministic re-processing and audit of matching outcomes. In some embodiments, the system is configured to store physical features of pages, such as rounded corners, gold leaf edges, and paper type, to create a comprehensive fingerprint for each entry to distinguish it from other editions without those features.

In some embodiments, the system is configured to store the information about illustrations, headers, sub headers, decorative elements, or other distinguishing features found on book pages. In some embodiments, the system is configured to store data on bleed-through effects, creases, and folds to account for physical wear and tear that may impact recognition. For example, the system is configured to store details about the ornate illustrations accompanying scripture passages in the Book of Psalms to ensure accurate matching even if the scanned page shows signs of wear.

In some embodiments, the system is configured to continuously or periodically update the characteristic database as new pages are scanned and analyzed, ensuring the database evolves to accommodate additional editions and formats. In some embodiments, the system is configured to use the database to compare scanned pages against stored entries, leveraging the unique traits and identifiers to determine the closest match.

In some embodiments, the system is configured to execute a matching process 109. In some embodiments, the system is configured to compare the output of the character recognition process 106 to a book and/or page database 108, where system is configured to identify the page and/or book (document) that the characters and/or features match. In some embodiments, the system is configured to output matched results 111.

In some embodiments, the system is configured to handle scenarios where multiple matches 110 occur, such as when identical pages exist in different books, and allows users to select the correct match through a graphical user interface (GUI). For example, in some embodiments, the system is configured to present users with a list of potential matches when identical pages are found in multiple versions of the Bible, enabling them to choose the correct version. In some embodiments, the system is configured to identify a one-to-one match between the scanned page and the database, determining the exact book and page from which the content originated.

In some embodiments, the system is configured to leverage user history to improve the matching process. In some embodiments, the system is configured to remember the books a user has previously interacted with or scanned, skewing the matching process toward those books. For example, in some embodiments, the system is configured to prioritize matches from a user’s preferred version of the Bible when a scripture page is scanned. In some embodiments, the system is configured to use sequential image submissions to infer that the pages belong to the same book, further refining the matching process. For example, in some embodiments, the system is configured to recognize that a user is scanning consecutive pages of a text and adjusts the matching process accordingly.

In some embodiments, the system is configured to accept additional input from users, such as voice commands identifying the book or page number, to enhance the accuracy of the matching process. In some embodiments, the system is configured to perform sentence-level localization on an identified page by analyzing a captured image that includes a user’s pointing gesture or any other type of indicator. In some embodiments, the system is configured to detect a fingertip, stylus tip, or on-page indicator within the captured image, estimate the indicator’s contact region relative to the page coordinate frame, and align the contact region to a sentence boundary using a combination of text line detection, character grouping, and sentence segmentation derived from the recognized text. In some embodiments, the system is configured to output the sentence index and the corresponding text span as a selection target for downstream actions such as audio playback, translation, annotation replication, or cross-reference retrieval. For example, in some embodiments, the system is configured to allow users to verbally specify the book, edition information and/or other identifying information that they are reading to assist in narrowing down the match.

In some embodiments, the system is configured to match the normalized page characteristics to a pre-existing database of book pages by analyzing unique patterns and traits. In some embodiments, the system is configured to build the database using various sources, including images derived from user submissions, publisher-provided print-ready files, and other clean documents. For example, in some embodiments, the system is configured to include print-ready files from publishers of religious texts to ensure clean and accurate matches. In some embodiments, the system is configured to identify a unique set of patterns and characteristics on the page, such as text layout, stylistic traits, and other distinguishing features, to create a collective identifier for matching purposes. In some embodiments, the system is configured to analyze a two-column layout or the presence of headers and sub headers that distinguish passages, such as Bible scripture passages, as a non-limiting example.

As discussed above, in some embodiments, the system is configured to evaluate features such as the number of colors, OCR results, whitespace amount, amount of text, language, font, lines per page, characters per line, page dimensions, paper type, rounded page corners, gold leaf, text locations, page number locations, stylistic traits, headers, sub headers, illustrations, bleed-through, and other distinguishing features. In some embodiments, the system is configured to use these characteristics to create a low-resolution fingerprint of the page, which can be compared against a database for efficient matching.

In some embodiments, the system is configured to convert the captured page into a low-resolution image by downscaling it to a smaller size, such as 100x100 pixels, while retaining the overall structure and layout. For example, in some embodiments, the system is configured to use this simplified image to identify the presence of columns, headers, or illustrations without processing the full high-resolution image, thereby improving computational efficiency, and reducing computer resources use.

In some embodiments, the system is configured to perform pattern matching using advanced methodologies. In some embodiments, the system is configured to execute a visual feature extraction that jointly detects interest keypoints and computes associated descriptors from an input image of a page. In some embodiments, the system is configured to apply a learned model that receives a normalized page image, identifies a plurality of keypoints distributed over text blocks, whitespace boundaries, decorative elements, and line break structures, and concurrently emits a compact descriptor for each keypoint to enable robust matching under perspective changes, partial occlusions, variable lighting, and user-added markings. In some embodiments, the system is configured to persist the emitted descriptors for later comparison against descriptors stored in a database, allowing the system to identify a page using local features without requiring full-resolution text processing.

In some embodiments, the system is configured to abstract page characteristics into a simplified format, such as a vector representation, for faster and more accurate matching. In some embodiments, the system is configured to use vector-based searches or other techniques to identify the closest match in the database. For example, in some embodiments, the system is configured to convert the layout of a scripture page into a vector representation that captures the relative positions of text blocks and whitespace for efficient comparison.

In some embodiments, the system is configured to distill page patterns into unique numerical identifiers or sampling specific regions of the page for comparison. For example, in some embodiments, the system is configured to sample specific regions of a Bible page (as opposed to the entire page of a document), such as the location of chapter headers or verse numbers, to refine the matching process. In some embodiments, the system is configured to overlay a grid on the page and evaluate specific regions, identifying whether they are black, white, or contain other patterns. In some embodiments, the system is configured to use this low-resolution fingerprint to compare the scanned page against the database and identify potential matches. In some embodiments, the system is configured to execute multiple approaches to ensure the most effective matching process is implemented using a variety of processed data.

In some embodiments, the system is configured to perform the matching process by referencing the database and simultaneously analyzing the scanned page. In some embodiments, the system is configured to ensure that the match occurs between the scanned page and the database, rather than solely within the database itself. In some embodiments, the system is configured to output match results once the scanned page has been successfully matched to an entry in the database. In some embodiments, the system is configured to store the match results for further processing and/or user interaction.

In some embodiments, the system is configured to use advanced methodologies to enhance the matching process. In some embodiments, the system is configured to analyze page characteristics using vector-based approaches, creating a vector representation of the page for efficient comparison. In some embodiments, the system is configured to perform fuzzy matching techniques to identify the closest match in the database. In some embodiments, the system is configured to execute spline analysis, as a non-limiting example, to identify inflection points and patterns within the scanned page. In some embodiments, the system is configured to reduce the scanned page’s characteristics into a single numerical identifier for faster matching.

In some embodiments, the system is configured to cascade the matching process based on confidence levels and processing speed. In some embodiments, the system is configured to initially perform a simplified match using numerical identifiers or low-resolution fingerprints. In some embodiments, the system is configured to refine the match by analyzing additional characteristics, which non-limiting examples include a number of colors, rounded corners, or even gold leaf on the page. In some embodiments, the system is configured to perform higher-level processing, such as OCR or detailed stylistic analysis, if necessary, to confirm the match.

In some embodiments, the system is configured to tier the matching process based on the likelihood of success and processing time. In some embodiments, the system is configured to prioritize characteristics that are most likely to yield accurate results, improving the efficiency of the matching process over time. In some embodiments, the system is configured to continuously refine its methodology as more data is collected and analyzed, ensuring that the matching process becomes increasingly accurate and reliable.

In some embodiments, the system is configured to extend functionality beyond the matching process by associating scanned pages with metadata and user-specific attributes. In some embodiments, the system is configured to attribute the matched book to the user, enabling the system to remember the user’s interaction history with that book. For example, in some embodiments, the system is configured to track a user’s engagement with a religious text, such as a Bible, and recall previously scanned pages for future interactions. In some embodiments, the system is configured to use metadata stored in the database to provide contextual information about the matched page, such as references, content, and attributes. For example, in some embodiments, the system is configured to provide cross-references for scripture passages, such as linking a verse in one book to related passages in another. In some embodiments, the system is configured to suggest related pages or content based on the user’s interaction with the matched book. As a non-limiting example, in some embodiments, the system is configured to recommend devotional readings or commentaries that correspond to the scanned scripture. In some embodiments, the system is configured to synchronize the user’s engagement with the physical book and its digital counterpart, allowing seamless navigation between formats. For example, in some embodiments, the system is configured to allow users to switch between reading a physical Bible and accessing the same content digitally on their mobile device.

In some embodiments, the system is configured to process markups and annotations on scanned pages. In some embodiments, the system is configured to compare the scanned page with a clean version stored in the database to identify highlights, notes, or other markings made by the user. For example, in some embodiments, the system is configured to detect handwritten notes in the margins of a Bible page (or any book/document) or underlined scripture passages. In some embodiments, the system is configured to recreate these annotations digitally within the digital version of the book. In some embodiments, the annotations are analyzed for context and can be stored for retrieval through searching by the user or by the system for recommendations to the original user or to others if permission has been obtained and digitally stored.

In some embodiments, the system is configured to replicate a user’s highlighted material in the system framework, preserving the color and style of the original highlighting. In some embodiments, the system is configured to index the page against its reference description, associating the user’s annotations with the corresponding metadata. For example, in some embodiments, the system is configured to associate a user’s note on a scripture passage with the metadata for that text, enabling easy retrieval and cross-referencing. In some embodiments, the system is configured to store the scanned page and its associated annotations in a user-specific database for future reference. In some embodiments, the system is configured to allow users to revisit their annotated pages, through a personalized digital archive.

In some embodiments, the system is configured to enable users to batch capture multiple pages in sequence, associating all captured pages with the same book for streamlined processing. In some embodiments, the system is configured to allow a user to scan an entire chapter of a religious text, for example, in one session, automatically linking all pages to the same book. In some embodiments, the system is configured to allow users to add custom metadata to scanned pages, such as personal notes or identifiers, to enhance organization and retrieval. For example, in some embodiments, the system is configured to let users tag a scanned page with “Grandma’s Bible” or “Grandma’s Notes” to distinguish it from other scanned books or portions.

In some embodiments, the system is configured to store analytics about scanned pages, such as frequently accessed content or user engagement patterns, for reporting purposes. For example, in some embodiments, the system is configured to track which scripture passages are most often scanned by a user and/or a group of system users. In some embodiments, the system is configured to provide publishers with insights into user behavior, such as page usage statistics or geographical trends, to support inventory regulation and marketing strategies. For example, in some embodiments, the system is configured to report that users in a specific region frequently scan and/or annotate certain pages from a religious document.

In some embodiments, the system is configured to perform pattern matching by analyzing pixel-level characteristics of scanned pages. In some embodiments, the system is configured to overlay a grid on the scanned page, dividing it into a set number of regions for analysis. In some embodiments, the system is configured to sample specific pixels within these regions, extracting their RGB values to create a simplified representation of the page. In some embodiments, the system is configured to compare the sampled RGB values against corresponding values in the database to determine whether the scanned page matches an entry. In some embodiments, the system is configured to reduce the pixel data into a single numerical identifier or vector representation, enabling efficient comparison and matching.

In some embodiments, the system is configured to use abstraction techniques to simplify the matching process. In some embodiments, the system is configured to analyze the scanned page without relying on the actual words or text content, focusing instead on patterns, shapes, and other visual characteristics. In some embodiments, the system is configured to distill the scanned page into a set of unique identifiers based on pixel sampling or other visual traits. In some embodiments, the system is configured to execute multiple methodologies for pattern matching, including vector-based approaches and numerical analysis, to identify the most effective method for accurate results for a particular dataset and/or user device.

In some embodiments, the system is configured to handle variations in scanned pages caused by motion, distortion, or static interference. In some embodiments, the system is configured to account for differences in pixel values caused by environmental factors, such as lighting or page curvature. In some embodiments, the system is configured to ensure that minor variations in pixel data do not prevent successful matching, using tolerance thresholds to accommodate discrepancies. In some embodiments, the system is configured to refine its matching process by testing different sampling techniques and adjusting its algorithms based on observed results.

In some embodiments, the system is configured to leverage preexisting metadata in the database to enhance the matching process. In some embodiments, the system is configured to associate scanned pages with contextual information, such as references, attributes, and related content, based on their pixel-level characteristics. In some embodiments, the system is configured to use this metadata to suggest additional pages or sections that may be relevant to the user’s interaction with the scanned book. In some embodiments, the system is configured to continuously or periodically improve its matching accuracy by analyzing user feedback and refining its methodologies over time.

In some embodiments, the system is configured to attribute the book to the user so that when the user returns, the system is aware of the book in use. For example, in some embodiments, the system is configured to recognize that a user has previously scanned pages from a Bible and automatically associate new scans with the same book. In some embodiments, the system is configured to utilize metadata associated with the pages in the database to provide contextual information about the content of the book. In some embodiments, the system is configured to provide metadata, such as chapter titles, scripture references, and/or thematic tags, for scanned pages of religious texts, as a non-limiting example. In some embodiments, the system is configured to reference and suggest specific pages to the user to locate and access particular content. For example, in some embodiments, the system is configured to recommend turning to a specific chapter in a Bible based on the user’s previous scans or interactions. In some embodiments, the system is configured to synchronize the user’s interaction with the book in a digital format, enabling the user to search or locate content across different pages in the printed material.

In some embodiments, the system is configured to index the page against a reference description of the book, including specific attributes such as the version of the book. In some embodiments, the system is configured to derive references and versions from the captured page when the database does not contain sufficient information. For example, in some embodiments, the system is configured to analyze the layout and stylistic traits of a scanned page to determine the version of the Bible it belongs to. In some embodiments, the system is configured to associate the indexed page with the user, storing the image along with its reference and version details. In some embodiments, the system is configured to store a user’s scanned pages of scripture, for example, along with metadata such as the book title, chapter, and verse numbers. In some embodiments, the system is configured to maintain a database of user-stored pages, allowing asynchronous processing of stored images to extract additional information. For example, in some embodiments, the system is configured to revisit previously stored pages to extract new insights, such as identifying additional annotations or improving text recognition.

In some embodiments, the system is configured to associate the book to the user, enabling the system to recognize the book during subsequent interactions. In some embodiments, the system is configured to utilize metadata associated with the pages in the database to provide contextual information about the book’s content. In some embodiments, the system is configured to suggest specific pages to the user based on the metadata, allowing the user to locate and access particular content. In some embodiments, the system is configured to synchronize the user’s interaction with the book in a digital format, enabling seamless navigation and content discovery across printed and digital formats.

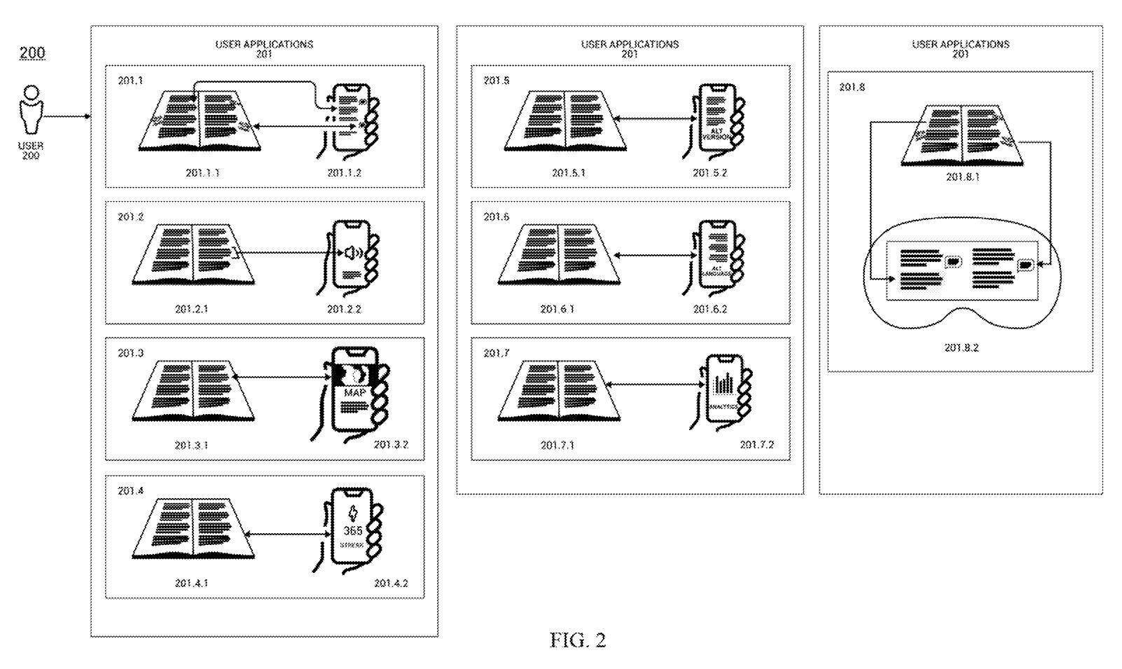

In some embodiments, the system is configured to provide user applications that enable interaction with scanned book content and enhance the reading experience. FIG. 2 illustrates various functionality which the system is configured to execute, in accordance with some embodiments. In some embodiments, the system is configured to process pages to extract markups, such as highlights, notes, underlines, or circles, added by the user or others. In some embodiments, the system is configured to compare the captured page with a clean version of the page stored in the database to identify and extract user-added annotations. For example, in some embodiments, the system is configured to detect handwritten notes in the margins of a Bible page or underlined scripture passages. In some embodiments, the system is configured to associate extracted highlights or notes with the corresponding digital version of the book.

For example, in some embodiments, the system is configured to replicate a user’s handwritten note 201.1 on a scripture passage in the system framework (e.g., database), preserving its location and context. In some embodiments, the system is configured to recreate user-added markups in a digital format 201.1.2, enabling the user to view their annotations digitally. For example, as shown in user applications 201, in some embodiments, the system is configured to display a user’s highlighted verses in the digital version of the Bible, allowing them to access their annotations across formats. In some embodiments, the system is configured to enhance the user’s engagement with the book by providing features such as audio playback, translation, and digital annotation synchronization.

In some embodiments, the system is configured to offer mapping features 201.3.2 that link book content to real-world geographical locations. In some embodiments, the system is configured to allow users to explore scripture passages tied to specific places, such as Jerusalem or the Sea of Galilee, enriching their understanding of the text. In a non-limiting example, the system is configured to generate a map with the locations mentioned in the Book of Acts, enabling users to visualize Paul’s missionary journeys.

In some embodiments, the system is configured to provide alternate versions 201.5.12 of scanned book content, allowing users to view translations, paraphrases, or adaptations of the text. In some embodiments, the system is configured to support alternate languages, enabling users to access scripture in their preferred language. For example, the system is configured to display a scanned page from the Book of Proverbs in both English and Spanish, allowing bilingual users to compare translations.

In some embodiments, the system is configured to include analytics features 201.7.2 that include tracking user engagement with scanned content. In some embodiments, the system is configured to measure reading progress, such as the number of pages read, or time spent on specific sections and provide reports for personal reflection or study planning. For example, the system is configured to track a user’s progress through the Book of Revelation and display completion percentages to encourage continued reading. In some embodiments, the system can identify an unusual amount of time spent on a specific section and recommend supplemental materials a user may find helpful.

In some embodiments, the system is configured to execute a game 201.4.2 that uses data based on the user’s progress. In some embodiments, the system is configured to gamify the reading experience by implementing leaderboards that track pages read, books completed, and reading speed. In some embodiments, the system is configured to allow users to compare their progress with others and participate in reading challenges. For example, the system is configured to display a leaderboard for users scanning scripture pages, showing the number of chapters completed in the Book of Psalms and encouraging friendly competition.

In some embodiments, the system is configured to present reading challenges to users, such as completing a set number of chapters or encountering new characters in the text. In some embodiments, the system is configured to offer global challenges that encourage exploration of diverse genres or themes. For example, the system is configured to challenge users to read two consecutive chapters, or to explore an academic commentary on biblical prophecy as part of a broader challenge.

In some embodiments, the system is configured to combine audio narration 201.2.2, alternate document version 201.5.12, multilingual text display 201.6.2, and digital annotation replication 201.1.2 to create an interactive and enriched reading experience.

In some embodiments, the system is configured to enhance the user’s engagement with the book by providing features such as batch image processing, augmented reality overlays 201.8.2, and digital annotation synchronization 201.8, allowing users to interact with printed books using AR-enabled or VR-enabled devices. In some embodiments, the system is configured to overlay digital highlights, notes, or translations onto printed text in near real time, enhancing the user’s reading experience. In some embodiments, the system is configured to transform printed text into alternate languages or formats, displaying the transformed content as an overlay through AR-enabled devices or phone cameras.

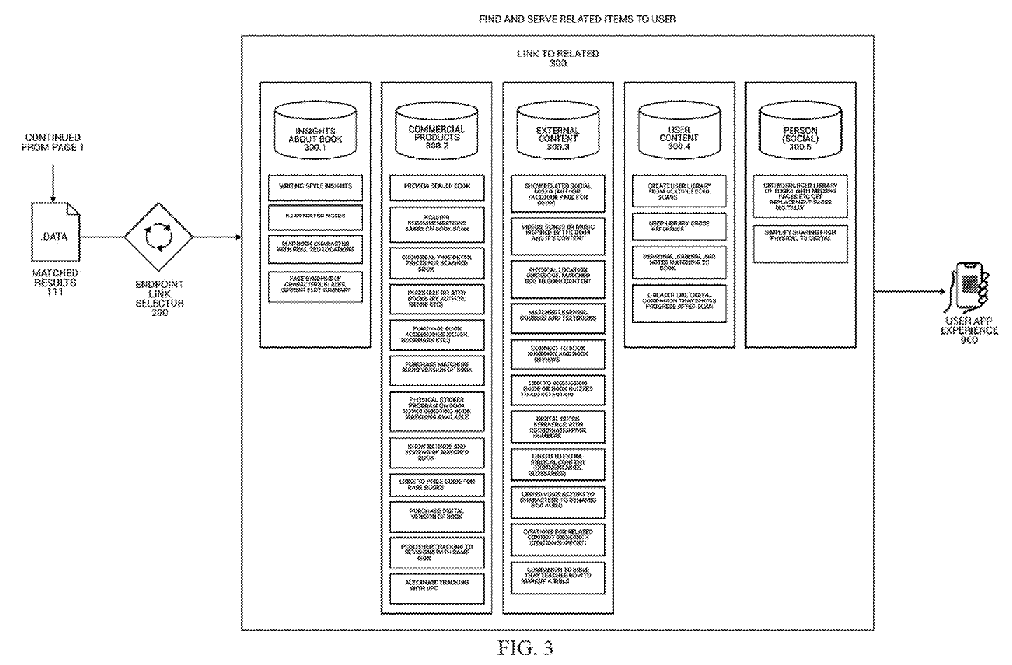

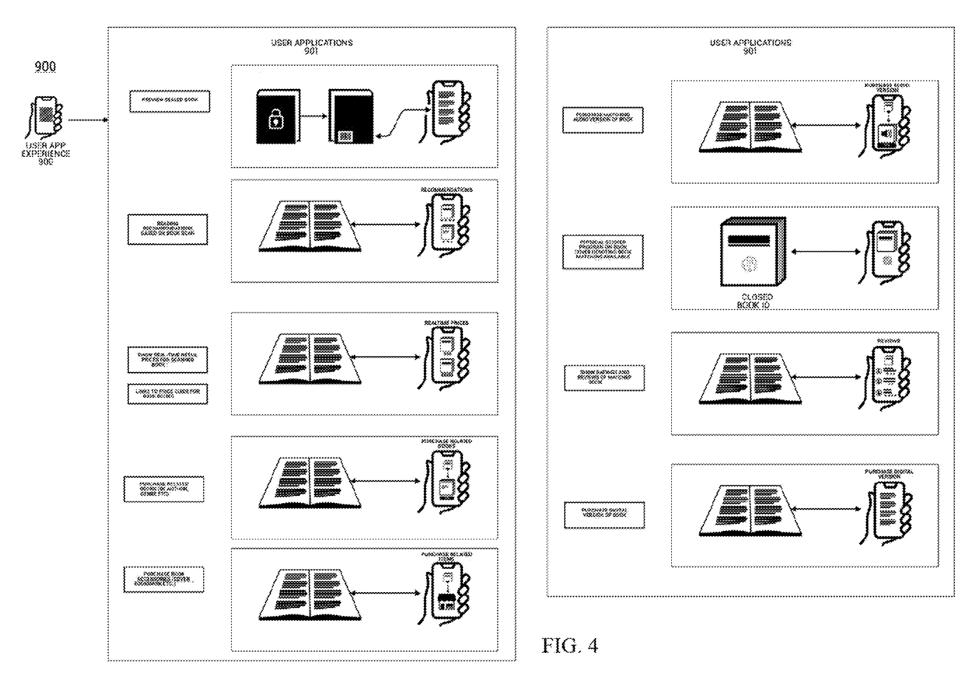

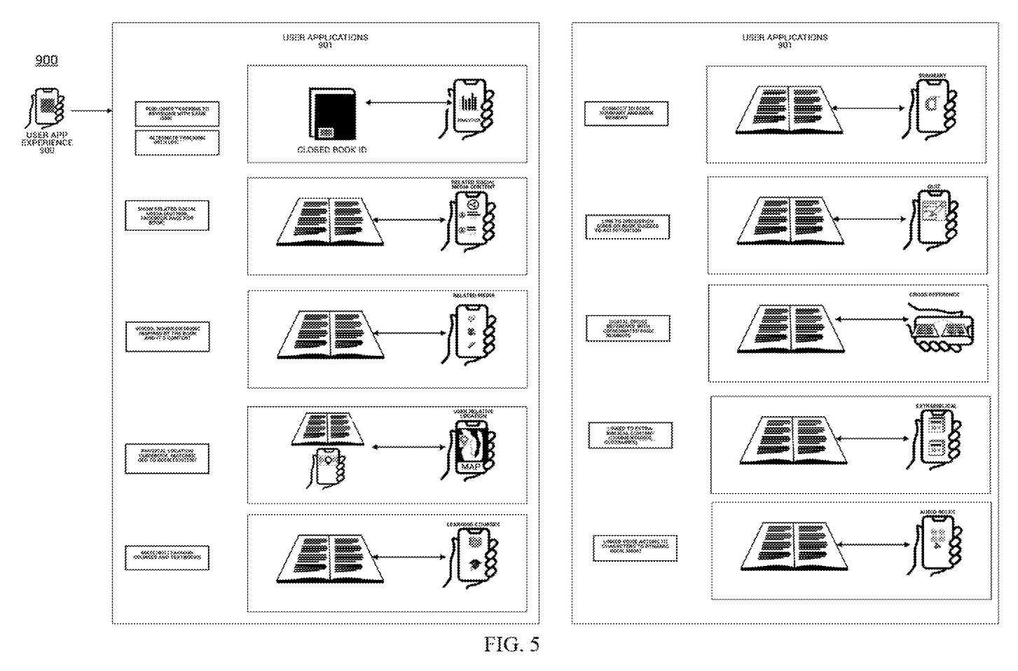

FIG. 3 shows additional features of the system that uses the matched results 111, in accordance with some embodiments. FIGS. 3 and 4 illustrate a user experience in relation to FIG. 3, in accordance with some embodiments. In some embodiments, the system includes an endpoint link selector configured to enable a user to select one or more system functions.

In some embodiments, the system is configured to provide insights 300.1 about book content, offering users a deeper understanding of the scanned material. In some embodiments, the system is configured to analyze the writing style of the book, including the author’s choice of words, sentence structure, tone, and literary techniques. For example, in some embodiments, the system is configured to highlight the poetic structure and parallelism in the Psalms, helping users appreciate the literary artistry of the scripture.

In some embodiments, the system is configured to include notes about illustrations within the book, providing context and details about their significance. In some embodiments, the system is configured to identify the illustrator and offer insights into their artistic contributions. For example, the system is configured to display information about the artist behind an illuminated manuscript of the Gospel of Matthew, enriching the user’s understanding of the visual elements.

In some embodiments, the system is configured to map book characters to real-world geographical locations, linking the narrative to historical or cultural contexts. In some embodiments, the system is configured to provide users with interactive maps that show where events in the book took place. For example, the system is configured to map the journey of the Israelites from Egypt to the Promised Land, as described in the Book of Exodus, allowing users to visualize the route and its significance.

In some embodiments, the system is configured to generate per-page synopses of the book, summarizing key themes, events, or characters for each page. In some embodiments, the system is configured to highlight important literary devices, historical settings, or references mentioned on the page. For example, the system is configured to summarize the events of the Last Supper in the Gospel of John, noting the use of symbolism and its theological implications.

In some embodiments, the system is configured to identify specific sub-genres within the book, such as poetry, prophecy, or narrative, and provide insights into their unique characteristics. In some embodiments, the system is configured to coordinate these sub-genres with related content, enabling users to explore similar themes across different books. For example, the system is configured to identify the prophetic genre in the Book of Isaiah and suggest connections to similar passages in the Book of Jeremiah.

In some embodiments, the system is configured to analyze characters within the book, identifying traits, relationships, and roles in the narrative. In some embodiments, the system is configured to provide psychological insights into characters, such as personality types or motivations. For example, the system is configured to describe the leadership qualities of Moses in the Book of Exodus, offering users a deeper understanding of his character and decisions.

In some embodiments, the system is configured to cross-reference book content with real-world geographical coordinates, allowing users to explore the historical and cultural settings of the narrative. In some embodiments, the system is configured to link scanned pages to multimedia resources, such as videos or images, that provide additional context. For example, the system is configured to connect a scanned page from the Book of Acts to a video explaining the historical significance of Pentecost, enhancing the user’s engagement with the text.

In some embodiments, the system is configured to provide commercial features 300.2 that enhance the user’s interaction with scanned book content and facilitate related purchases. In some embodiments, the system is configured to allow users to preview sealed books digitally, offering a cursory look at the content before making a purchase. For example, in some embodiments, the system is configured to provide a digital preview of a Bible commentary, enabling users to view sample pages and assess relevance to their study needs.

In some embodiments, the system is configured to offer reading recommendations based on the last scanned book, suggesting related titles or genres for further exploration. In some embodiments, the system is configured to recommend books by the same author or within the same thematic category. For example, the system is configured to suggest a devotional book on the Psalms after a user scans a page from the Book of Psalms.

In some embodiments, the system is configured to utilize physical stickers or other devices for marketing purposes, advertising the book-matching system with an “ensured match” feature. In some embodiments, the system includes adding these stickers on book covers to guarantee accurate identification during scanning. For example, the system is configured to use a sticker on the cover of a Bible to ensure seamless matching with its corresponding digital version.

In some embodiments, the system is configured to display real-time retail prices for scanned books, enabling users to compare costs across different stores. In some embodiments, the system is configured to link users to online retailers for immediate purchase. For example, the system is configured to show the current price of a scanned study Bible at various online and physical retailers.

In some embodiments, the system is configured to facilitate the purchase of related books by the same author or within the same genre. In some embodiments, the system is configured to display ratings and reviews of the scanned book, helping users make informed decisions. For example, in some embodiments, the system is configured to show user reviews of a scanned Bible translation, highlighting its readability and accuracy.

In some embodiments, the system is configured to allow publishers to track revisions that are too granular for a new ISBN, ensuring consistency across editions. In some embodiments, the system is configured to enable users to purchase book accessories, such as Bible cases, bookmarks, or highlighters, that complement the scanned book. For example, the system is configured to recommend a scripture-themed bookmark after scanning a Bible page.

In some embodiments, the system is configured to match scanned books with their audio versions for purchase, enabling users to access narrated content. In some embodiments, the system is configured to suggest streaming services where the audio content is available. For example, the system is configured to recommend an audio Bible recording corresponding to a scanned scripture page.

In some embodiments, the system is configured to link scanned books to price guides, showing suggested prices and enabling users to make offers or assess historical value. In some embodiments, the system is configured to facilitate efficient shipping for purchased books. For example, the system is configured to provide pricing information for rare editions of the Bible, helping users determine their value in the marketplace.

In some embodiments, the system is configured to enable partial book purchases, allowing users to buy only the remainder of a book they have partially read. In some embodiments, the system is configured to support alternate scanning methods, such as using a UPC code for sealed books, to associate the book with its digital counterpart. For example, the system is configured to allow a user to scan a sealed Bible and purchase its digital version for immediate access.

In some embodiments, the system is configured to connect scanned book content to external content 300.3, enriching the user’s experience and providing additional context. In some embodiments, the system is configured to display related social media channels, such as an author’s YouTube channel or a Facebook discussion page dedicated to the book. For example, the system is configured to link a scanned page from the Book of Proverbs to a Facebook group discussing wisdom literature, enabling users to engage in conversations about the text.

In some embodiments, the system is configured to provide access to videos, songs, or music inspired by the book and its content. In some embodiments, the system is configured to suggest multimedia resources that complement the themes or narratives of the scanned page. For example, in some embodiments, the system is configured to recommend hymns inspired by the Book of Psalms after scanning a scripture passage, allowing users to explore musical interpretations of the text.

In some embodiments, the system is configured to create a physical location guidebook that matches real-world geographical coordinates to locations mentioned in the book. In some embodiments, the system is configured to provide step-by-step directions to landmarks referenced in the text. For example, in some embodiments, the system is configured to guide users to the Valley of Elah after scanning a page about David and Goliath in the Book of Samuel, enabling them to visit the historical site.

In some embodiments, the system is configured to match scanned book content to learning courses and textbook material, offering educational resources tied to the text. In some embodiments, the system is configured to suggest study guides or academic commentaries that expand on the themes of the scanned page. For example, in some embodiments, the system is configured to recommend a theology course on the Book of Revelation after scanning a page from the same book.

In some embodiments, the system is configured to connect scanned pages to book summaries and reviews, enabling users to access condensed versions of the text or insights from other readers. In some embodiments, the system is configured to link users to discussion guides or book quizzes to reinforce learning and retention. For example, in some embodiments, the system is configured to provide a quiz on the parables of Jesus after scanning a page from the Gospel of Matthew, helping users test their understanding of the text.

In some embodiments, the system is configured to offer digital cross-references with coordinated page numbers, allowing users to navigate related content across different books. In some embodiments, the system is configured to link scanned pages to extra-biblical content, such as commentaries, glossaries, or explanations of people, places, and events. In some embodiments, the system is configured to provide a glossary of Hebrew terms after scanning a page from the Book of Isaiah to help users understand the original language of the scripture.

In some embodiments, the system is configured to connect book characters to voice actors, creating dynamic audio experiences tied to the scanned content. In some embodiments, the system is configured to provide narrated versions of the book where different voice actors represent specific characters. For example, the system is configured to offer an audio narration of the Book of Exodus with distinct voices for Moses, Pharaoh, and Aaron, enhancing the storytelling experience.

In some embodiments, the system is configured to link scanned pages to citations for related or supported content, enabling users to explore research or multimedia references tied to the text. In some embodiments, the system is configured to provide a companion resource that teaches users how to mark up their books, including explanations of key terms and cross-references. For example, the system is configured to guide users in highlighting significant Hebrew words and provide commentary on their meanings.

In some embodiments, the system is configured to enable the user to create and/or store user content 300.4. As a non-limiting example, in some embodiments, the system is configured to enable users to create a personal library by scanning multiple books and digitally organizing them. In some embodiments, the system is configured to compile scanned pages into a unified library, allowing users to access their collection across different formats. For example, the system is configured to allow a user to scan pages from the Book of Exodus, a devotional guide, and a Bible atlas, organizing them into a searchable digital library for study and reference.

In some embodiments, the system is configured to cross-reference scanned books within the user’s library, highlighting connections between related content. In some embodiments, the system is configured to identify scripture passages that appear in multiple scanned books and link them for seamless navigation. For example, the system is configured to connect a scanned page from the Book of Isaiah to a commentary that discusses the same prophetic themes, enriching the user’s understanding of the text.

In some embodiments, the system is configured to allow users to create a personal journal by adding notes and reflections tied to specific scanned pages. In some embodiments, the system is configured to index these notes and match them to the corresponding book content for easy retrieval. For example, the system is configured to enable a user to save reflections on the story of David and Goliath and organize these notes in a searchable journal tied to the scripture.

In some embodiments, the system is configured to provide an e-reader digital companion that tracks reading progress after a book scan. In some embodiments, the system is configured to display features such as font style, size, line spacing, and percentage completion to enhance the reading experience. For example, the system is configured to show a user their progress through the Book of Revelation, including the percentage of chapters completed, encouraging continued engagement with the text. In a non-limiting example, the system is configured to adjust font size and spacing for easier reading of passages.

In some embodiments, the system is configured to create a crowdsourced library of books, enabling users to contribute scanned pages from different sources to digitally reconstruct complete books. In some embodiments, the system is configured to allow users to access pristine versions of books, even if their personal copies are damaged or incomplete. For example, in some embodiments, the system is configured to provide a clean digital version of the Book of Job to a user whose physical copy has torn pages or markings.

In some embodiments, the system is configured to simplify sharing between physical and digital formats, allowing users to share scanned content with others seamlessly. In some embodiments, the system is configured to enable users to share highlights, notes, and annotations tied to specific pages. For example, in some embodiments, the system is configured to allow a user to share their highlighted verse, along with personal reflections, with friends or study groups.

In some embodiments, the system is configured to execute virtual book club programs, enabling participants to see each other’s reading progress and engage in discussions about the content. In some embodiments, the system is configured to link conversation threads to specific parts of the book, fostering collaborative engagement. For example, in some embodiments, the system is configured to allow users to discuss themes of wisdom and share insights on individual verses in a virtual group setting.

In some embodiments, the system is configured to display friend-connected content that relates to the scanned book, such as highlights, notes, or contributions from others. In some embodiments, the system is configured to notify users when their friends have annotated or commented on a passage in the same book. For example, in some embodiments, the system is configured to alert a user when a friend has added notes, allowing them to view and interact with shared insights.

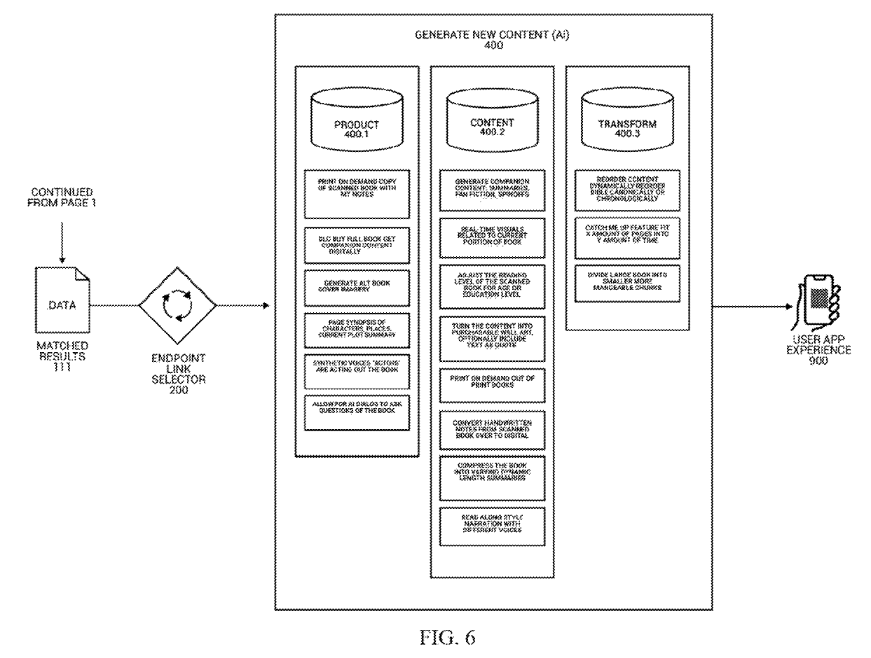

FIG. 6 shows system generation processes 400 in accordance with some embodiments. In some embodiments, the system is configured to enable users to generate physical and digital products based on scanned book content, enhancing personalization and accessibility. In some embodiments, the system is configured to allow users to print on-demand copies of scanned books, including their personal notes and annotations. For example, in some embodiments, the system is configured to create a printable version of the Book of Psalms, incorporating a user’s handwritten reflections and highlighted verses.

In some embodiments, the system is configured to offer downloadable content (DLC) that provides users with full digital versions of scanned books, along with companion resources. In some embodiments, the system is configured to include additional materials, such as study guides or multimedia content, to complement the scanned book. As a non-limiting example, in some embodiments, the system is configured to provide a digital copy of the Gospel of John, accompanied by a commentary and video series explaining its theological themes.

In some embodiments, the system is configured to generate alternate book cover imagery for scanned books, allowing users to customize the appearance of their physical or digital copies. In some embodiments, the system is configured to suggest and/or generate designs inspired by the content or themes of the book. In some embodiments, the system is configured to create a custom cover for the Book of Revelation, featuring imagery of the New Jerusalem and the Tree of Life, as a non-limiting example.

In some embodiments, the system is configured to provide page synopses that summarize the characters, places, and current plot details of the scanned book. In some embodiments, the system is configured to highlight key themes and events for each page to enhance comprehension. For example, in some embodiments, the system is configured to summarize the events of the Exodus on a scanned page from the Book of Exodus, noting Moses’ leadership and the crossing of the Red Sea.

In some embodiments, the system is configured to generate synthetic voice narrations of scanned books, where voice actors dynamically act out the content. In some embodiments, the system is configured to assign distinct voices to characters, creating an immersive audio experience. For example, in some embodiments, the system is configured to narrate the Book of Ruth with unique voices for Ruth, Naomi, and Boaz, bringing the story to life for the listener.

In some embodiments, the system is configured to enable users to interact with scanned book content through AI-driven dialogue, allowing them to ask questions about the text. In some embodiments, the system is configured to provide contextual answers based on the scanned material and related resources. For example, in some embodiments, the system is configured to allow a user to ask questions about the Sermon on the Mount in the Gospel of Matthew, such as the meaning of the Beatitudes, and receive detailed explanations tied to the scripture.

In some embodiments, the system is configured to generate companion content 400.2 based on scanned book pages, offering users additional resources to deepen their engagement with the material. In some embodiments, the system is configured to create summaries, fan fiction, or spinoff stories inspired by the scanned book content using generative AI. For example, in some embodiments, the system is configured to generate a condensed summary of the Book of Ecclesiastes, highlighting its themes of wisdom and the pursuit of meaning.

In some embodiments, the system is configured to provide real-time visuals related to the current portion of the scanned book, enhancing the user’s understanding of the text. In some embodiments, the system is configured to generate images or animations that illustrate key themes or events. For example, in some embodiments, the system is configured to create an animated depiction of the parting of the Red Sea after scanning a page from the Book of Exodus, visually representing the narrative.

In some embodiments, the system is configured to adjust the reading level of scanned book content to suit the user’s age or education level. In some embodiments, the system is configured to simplify complex language or concepts for easier comprehension. For example, in some embodiments, the system is configured to adapt the text of the Book of Isaiah for younger readers, simplifying prophetic imagery while preserving the core message.

In some embodiments, the system is configured to transform scanned book content into purchasable wall art, generating images inspired by the text. In some embodiments, the system is configured to include quotes from the book as part of the artwork. For example, in some embodiments, the system is configured to create a decorative print featuring the verse “The Lord is my shepherd” from Psalm 23, accompanied by an artistic rendering of pastoral imagery.

In some embodiments, the system is configured to enable print-on-demand services for out-of-print books, allowing users to obtain physical copies of rare or unavailable texts. In some embodiments, the system is configured to include user-added notes and annotations in the printed version. For example, in some embodiments, the system is configured to allow a user to scan pages from an out-of-print Bible and order a printed copy that incorporates their handwritten reflections.

In some embodiments, the system is configured to convert handwritten notes from scanned pages into digital text, preserving user annotations for future use. In some embodiments, the system is configured to integrate these notes into the digital version of the book. For example, in some embodiments, the system is configured to digitize a user’s margin notes on the parables of Jesus from the Gospel of Luke and associate them with the corresponding scripture.

In some embodiments, the system is configured to compress the scanned book content into varying dynamic-length summaries, offering users high-level overviews or detailed expansions as needed. In some embodiments, the system is configured to allow users to toggle between condensed and full versions of the text. For example, in some embodiments, the system is configured to generate a skeleton outline of the Book of Revelation, summarizing its chapters and key themes, with the option to expand into the full text for deeper study.

In some embodiments, the system is configured to provide read-along style narration for scanned books, using different, user or system selectable, voices to enhance the experience. In some embodiments, the system is configured to synchronize the narration with the text. For example, in some embodiments, the system is configured to narrate the story of the Prodigal Son from the Gospel of Luke, assigning distinct voices to the father, son, and brother to bring the parable to life.

In some embodiments, the system is configured to dynamically reorder the content of scanned books, allowing users to view the material in alternate organizational formats. In some embodiments, the system is configured to rearrange the structure of a book based on user preferences, such as chronological or thematic order. For example, in some embodiments, the system is configured to reorder the books of the Bible from canonical order to chronological order, enabling users to read scripture in the sequence of historical events, such as starting with Genesis and Job.

In some embodiments, the system is configured to implement a “Catch me up” feature that condenses content to fit a specified number of pages into a designated time frame. In some embodiments, the system is configured to summarize and streamline the material while preserving key themes and messages. For example, in some embodiments, the system is configured to condense the Book of Isaiah into a summary that fits within a 30-minute reading session, highlighting its prophetic visions and major chapters.

In some embodiments, the system is configured to divide large books into smaller, more manageable sections, making them easier to navigate and read. In some embodiments, the system is configured to segment the content into logical sections based on themes, chapters, or narrative arcs. For example, in some embodiments, the system is configured to split a Book of the Bible into thematic groupings, such as psalms of praise, lament, and thanksgiving, allowing users to focus on one category at a time.

In some embodiments, the system is configured to transform scanned book content into alternate formats that align with user preferences or study goals. In some embodiments, the system is configured to allow users to interact with the reorganized material, enabling personalized exploration of the text.

In some embodiments, the system is configured to index the page against a reference description of the book, including specific attributes such as the version of the book. In some embodiments, the system is configured to derive references and versions from the captured page when the database does not contain sufficient information. In some embodiments, the system is configured to associate the indexed page with the user, storing the image along with its reference and version details. In some embodiments, the system is configured to maintain a database of user-stored pages, allowing processing of stored images to extract additional information as understanding advances.

As described previously, the system is configured to display the same content in alternate languages using generative artificial intelligence (AI) for translation or pre-existing versions of the text in multiple languages. In some embodiments, the system is configured to provide digital access to alternate versions of the same text, enabling users to view content in different languages. In some embodiments, the system is configured to play audio content corresponding to the matched page, either through pre-recorded audio files or synthetic voice generation. In some embodiments, the system is configured to synchronize audio playback with the text on the matched page, creating a seamless experience for the user.

As mentioned above, in some embodiments, the system is configured to provide audio playback using pre-recorded audio files or synthetic voice generation. In some embodiments, the system is configured to utilize a synthetic voice to read the text on the matched page aloud when a pre-recorded audio version of the book is unavailable. In some embodiments, the system is configured to allow users to access audio content regardless of whether pre-recorded files exist for the book.

In some embodiments, the system is configured to enhance the user’s engagement with the book by providing features such as multimedia content synchronization, audio playback, and related content discovery. For example, in some embodiments, the system is configured to offer a combination of video explanations, textual commentaries, and audio recordings to create a comprehensive and interactive reading experience.

In some embodiments, the system is configured to capture audio input and match it to corresponding text content within a database. In some embodiments, the system is configured to identify the matched text and display it to the user. For example, in some embodiments, the system is configured to listen to an audio Bible being played or a sermon and bring up the corresponding text version on the user’s device.

In some embodiments, the system is configured to utilize audio fingerprinting techniques to analyze the audio input and identify matching text content. In some embodiments, the system is configured to process the audio input and compare it to pre-existing audio-text mappings within the database. For example, in some embodiments, the system is configured to capture audio from a speech or lecture and match it to relevant text passages stored in the database.

In some embodiments, the system is configured to enhance the user’s engagement with audio content by providing synchronized text displays that correspond to the audio input. In some embodiments, the system is configured to allow users to interact with the matched text, such as by highlighting or annotating specific sections. For example, in some embodiments, the system is configured to enable users to annotate scripture passages that correspond to the audio they are listening to.

In some embodiments, the system is configured to support multiple input types, such as audio, text, or images, and process each input to identify corresponding content within the database. In some embodiments, the system is configured to provide a seamless user experience by integrating audio recognition and text matching functionalities. For example, in some embodiments, the system is configured to allow users to switch between listening to audio content and viewing matched text content without interruption.

In some embodiments, the system is configured enable a user to sell related products, such as bookmarks, cases, and highlighters, that complement the scanned book. For example, in some embodiments, the system is configured to recommend a Bible case or scripture-themed bookmark after scanning a Bible page. In some embodiments, the system is configured to utilize physical stickers that cooperate with the book-matching system with an “ensured match” when scanned. For example, in some embodiments, the system includes a sticker or other indicator on the cover of a Bible that guarantees accurate identification and matching when scanned.

In some embodiments, the system is configured to adjust text for dyslexia by using specialized fonts designed to improve readability for users with dyslexia. For example, in some embodiments, the system is configured to display scripture passages, such as Psalm 23, in a dyslexic-friendly font when scanned, ensuring accessibility for users with reading challenges. In some embodiments, the system is configured to magnify text for easier reading, allowing users to view content in larger, more legible formats. For example, in some embodiments, the system is configured to magnify the text of a scanned Bible page, making it easier for users with visual impairments to read scripture.

In some embodiments, the system is configured to provide Braille text with the same affordances as printed text, enabling users to interact with Braille versions of books in similar ways. For example, in some embodiments, the system is configured to allow users to scan a Braille Bible page and access features such as annotations, highlights, or cross-references.

In some embodiments, the system is configured to create dynamic guidebooks that integrate geo-coordinates for physical tours, enabling users to explore locations tied to the book’s content. In some embodiments, the system is configured to guide users through a walking tour, such as of Jerusalem, based on scanned scripture pages, offering step-by-step directions to landmarks mentioned in the Bible.

In some embodiments, the system is configured to overlay “Choose Your Own Adventure” paths onto existing books, allowing users to navigate the content in interactive and personalized ways. For example, in some embodiments, the system is configured to enable users to scan a Bible page and choose alternate paths through scripture, such as focusing on thematic studies like forgiveness or prophecy. In some embodiments, the system is configured to create alternate endings or summaries based on user preferences, providing tailored reading experiences. For example, in some embodiments, the system is configured to summarize the Book of Revelation in view of modern events for users who prefer a more adventurous version of its prophetic themes.

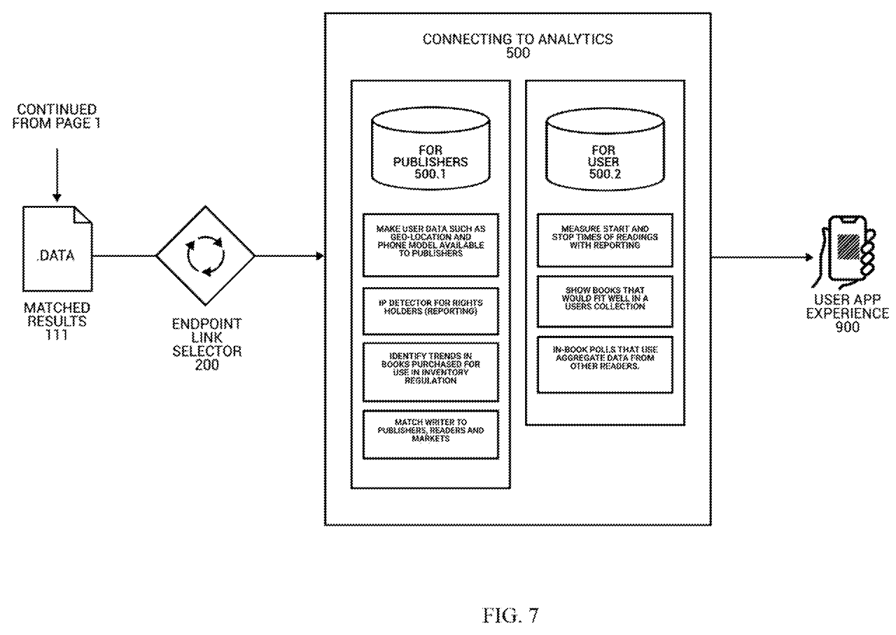

FIG. 7 depicts an analytics process 500 configured to provide insights on user behavior, in accordance with some embodiments. In some embodiments, the system is configured to provide publishers 500.1 with valuable insights and tools to enhance their understanding of user interactions with scanned book content. In some embodiments, the system is configured to make user data, such as geographical location and device information, available to publishers for analysis and decision-making. For example, the system is configured to report that users in a specific region frequently scan pages from the Book of Genesis, enabling publishers to tailor their marketing strategies to regional preferences.

In some embodiments, the system is configured to implement an intellectual property detector for rights holders, identifying other works where the scanned book content has been used. In some embodiments, the system is configured to provide reporting on derivative works or adaptations tied to the scanned book. For example, the system is configured to detect references to in a scanned devotional book and notify the rights holder of its inclusion. In some embodiments, copyright licensing and/or permissions may be partially or fully automated.

In some embodiments, the system is configured to identify trends in books purchased or scanned, offering insights into inventory regulation and market demand. In some embodiments, the system is configured to analyze user behavior to determine which genres, themes, or editions are most popular. For example, in some embodiments, the system is configured to report increased interest in study Bibles featuring commentary on the Book of Revelation, helping publishers adjust their inventory to meet demand.

In some embodiments, the system is configured to match writers to publishers, readers, and markets, facilitating connections that align with user interests and publishing goals. In some embodiments, the system is configured to recommend authors based on their expertise or alignment with market trends. For example, in some embodiments, the system is configured to suggest a writer specializing in biblical prophecy to a publisher seeking contributors for a new commentary series on the prophetic books of the Bible.

In some embodiments, the system is configured to provide users 500.2 with tools and insights to enhance their reading experience and engagement with scanned book content. In some embodiments, the system is configured to measure start and stop times of reading sessions and generate reports based on user activity. In some embodiments, the system is configured to display metrics such as time spent on specific chapters or pages. For example, in some embodiments, the system is configured to track a user’s reading time for the Book of Proverbs and provide a heat map showing which verses were most frequently revisited.

In some embodiments, the system is configured to recommend books that would complement a user’s existing collection, helping them discover new content. In some embodiments, the system is configured to analyze scanned books in the user’s library and suggest related titles based on themes, genres, or authors.

In some embodiments, the system is configured to include in-book polls that aggregate data from other readers to provide interactive and engaging experiences. In some embodiments, the system is configured to present questions or prompts tied to the scanned content, allowing users to compare their responses with others. For example, the system is configured to ask users scanning the Book of Jonah whether they interpret the story as a literal event or a symbolic narrative, displaying the aggregated results from the broader user base.

In some embodiments, the system is configured to provide users with personalized insights and recommendations based on their reading habits and preferences. In some embodiments, the system is configured to encourage continued engagement by highlighting progress and suggesting new challenges as part of the game structure described herein. For example, in some embodiments, the system is configured to notify a user that they are close to completing the Book of Psalms and suggest starting the Book of Isaiah as their next reading goal.

In some embodiments, the system is configured to execute a cascaded processing sequence to identify a book and page corresponding to a captured image of a physical book page. In some embodiments, the cascaded processing sequence is configured to apply processing operations in order of increasing computational intensity, beginning with the least resource-intensive operations and escalating to more computationally demanding operations only when a prior processing level produces a confidence level that is insufficient to identify the captured page. In some embodiments, this cascaded approach is configured to improve the overall processing efficiency of the system by reserving the most computationally intensive processing operations for only those captured images that could not be matched at a lower processing level, reducing the computational resources and processing time required to produce a match result for the majority of captured images that are successfully matched at an earlier processing level.

In some embodiments, the cascaded processing sequence comprises a first-level processing sequence, a second-level processing sequence, and a third-level processing sequence, each of which is configured to apply a distinct type of analysis to the captured image and each of which is configured to either output a match result upon satisfaction of a corresponding confidence threshold or generate an escalation signal that initiates the next processing level in the sequence. For example, in some embodiments, the system is configured to apply the cascaded processing sequence to a captured image of a physical book page received from a smartphone camera, executing each processing level in sequence until a match result is produced that identifies the book, edition, and page corresponding to the captured image with sufficient confidence to enable downstream processing.

In some embodiments, the system is configured to execute a first-level processing sequence upon receiving a captured image of a physical book page from a user device. In some embodiments, the system is configured to initiate the first-level processing sequence as a default processing for all captured images. For example, in some embodiments, the system is configured to receive a captured image from a smartphone camera directed at a page of a physical book, such as a Bible, magazine, or electronic display, and immediately queue the captured image for first-level processing.

In some embodiments, the system is configured to store the captured image as a raw input file prior to processing. In some embodiments, the system is configured to associate the raw input file with a session identifier and a user identifier at the time of storage to enable retrieval and attribution during subsequent processing stages. For example, in some embodiments, the system is configured to assign a session identifier to a raw input file generated when a user captures an image of a page from a religious text, preserving the association between the user and the captured content for use throughout the processing sequence.

In some embodiments, the system is configured to execute a corrective normalization process on the captured image to generate a normalized output prior to analysis. In some embodiments, the corrective normalization process is configured to address one or more of skew, white balance, blur, rotation, bleed-through, glare, and obstruction artifacts present in the captured image to produce a normalized output suitable for downstream processing. In a non-limiting example, the system is configured to normalize a captured image of a scripture page photographed under uneven ambient lighting, correcting for brightness variation and text obscuration to generate a normalized output in which the text and layout of the page are accurately represented.

In some embodiments, the system is configured to convert the normalized output into a low-resolution representation by downscaling the normalized image to a reduced pixel size. In some embodiments, the system is configured to retain the overall structural and layout characteristics of the page within the low-resolution representation while discarding fine-grained detail that is not necessary for first-level processing. In some embodiments, the downscaling process is configured to reduce the computational resources required for subsequent analysis steps, improving the processing efficiency of the system relative to approaches that operate on full-resolution images. As a non-limiting example, in some embodiments, the system is configured to downscale a normalized image of a Bible page to a lower-resolution representation of approximately 100x100 pixels, preserving structural features such as column layout and header placement while reducing the data volume processed during the analysis stage.

In some embodiments, the system is configured to overlay a grid on the low-resolution representation, dividing the low-resolution representation into a set number of regions for analysis. In some embodiments, the system is configured to apply the grid uniformly across the low-resolution representation such that each region corresponds to a defined spatial area of the page. For example, in some embodiments, the system is configured to divide the low-resolution representation of a scanned book page into a grid of equal-sized regions that individually capture portions of the page corresponding to text blocks, whitespace margins, and structural elements such as headers or illustrations.

In some embodiments, the system is configured to sample specific pixels within each region of the grid. In some embodiments, the system is configured to extract pixel data from the sampled pixels, including color channel values such as RGB values, to generate a simplified data representation of each region. For example, in some embodiments, the system is configured to sample pixels within each grid region of a normalized Bible page and extract their RGB values to capture the distribution of ink, whitespace, and visual elements across the page in a compact data format.

In some embodiments, the system is configured to reduce the extracted pixel data into a numerical identifier representing a low-resolution fingerprint of the captured page. In some embodiments, the system is configured to derive the numerical identifier from the aggregated pixel data across all sampled regions, generating a compact representation that encodes the visual structure of the page in a format suitable for rapid database comparison. In a non-limiting example, the system is configured to reduce the pixel data sampled from a grid-divided low-resolution representation of a scripture page into a single numerical identifier that captures the relative distribution of text, whitespace, and non-text visual features across the page.

In some embodiments, the system is configured to compare the numerical identifier against corresponding entries stored in a characteristic database. In some embodiments, the characteristic database is configured to store numerical identifiers and associated metadata for a plurality of book pages, enabling the system to evaluate the similarity between the numerical identifier derived from the captured image and the identifiers associated with stored entries. For example, in some embodiments, the system is configured to query the characteristic database using the numerical identifier derived from a captured Bible page to identify stored entries whose numerical identifiers most closely correspond to the captured page.

In some embodiments, the system is configured to evaluate the result of the comparison to determine a confidence level for a potential match between the captured page and one or more entries in the characteristic database. In some embodiments, the system is configured to determine whether the confidence level satisfies a first threshold sufficient to identify at least one of the book and the page from which the captured image was derived. In some embodiments, the first threshold is configured to represent the minimum confidence level at which the system determines that the numerical identifier comparison alone is sufficient to produce a reliable match result without requiring additional processing. For example, in some embodiments, the system is configured to evaluate whether the confidence level generated by comparing the numerical identifier of a captured scripture page against the characteristic database is sufficient to identify the corresponding edition and page of the Bible without escalating to more computationally intensive processing.

In some embodiments, the system is configured to output a match result identifying at least one of the book and the page corresponding to the captured image when the confidence level satisfies the first threshold. In some embodiments, the match result is configured to include metadata associated with the matched entry in the characteristic database, such as the book title, edition information, and page number. For example, in some embodiments, the system is configured to output a match result identifying the specific version and page of a Bible when the numerical identifier derived from a captured image of a scripture page produces a confidence level that satisfies the first threshold.

In some embodiments, the system is configured to generate a first escalation signal when the confidence level does not satisfy the first threshold. In some embodiments, the first escalation signal is configured to initiate a second-level processing sequence that applies additional page characteristic extraction and analysis to the captured image using greater computational resources. In a non-limiting example, the system is configured to generate a first escalation signal when a captured image of a Bible page that includes physical distinguishing features, such as an edge finish characteristic (e.g., gold leaf) or a page corner geometry (e.g., rounded corners), produces a numerical identifier whose confidence level falls below the first threshold, indicating that additional feature analysis is required to distinguish the captured page from similar entries in the characteristic database.

In some embodiments, the system is configured to store at least the normalized image, the numerical identifier, and the confidence level upon completion of the first-level processing sequence, regardless of whether a match result is output or a first escalation signal is generated. In some embodiments, the stored data is configured to be retrieved and used as input for second-level processing when the first escalation signal has been generated, avoiding redundant reprocessing of the captured image and preserving the computational work performed during the first-level processing sequence. For example, in some embodiments, the system is configured to store the normalized image and numerical identifier derived from a captured scripture page alongside the session identifier and user identifier assigned at the time of raw input file creation, enabling seamless retrieval of all first-level processing outputs when the second-level processing sequence is initiated.

In some embodiments, the system is configured to execute a second-level processing sequence upon receiving a first escalation signal generated during the first-level processing sequence. In some embodiments, the system is configured to treat the first escalation signal as a discrete trigger that initiates the second-level processing sequence without requiring additional input from the user, enabling the escalation to occur automatically and transparently during a single user interaction. For example, in some embodiments, the system is configured to automatically initiate the second-level processing sequence when a captured image of a physical book page, such as a Bible page, produces a numerical identifier during first-level processing whose confidence level falls below the first threshold, indicating that the low-resolution fingerprint alone was insufficient to distinguish the captured page from one or more similar entries in the characteristic database.

In some embodiments, the system is configured to retrieve the normalized image, the numerical identifier, and the confidence level stored during the first-level processing sequence upon receiving the first escalation signal. In some embodiments, the system is configured to use the retrieved data as the starting point for second-level processing, avoiding redundant re-execution of the corrective normalization process and the low-resolution fingerprint generation steps performed during the first-level processing sequence. In a non-limiting example, the system is configured to retrieve the normalized image of a scripture page stored during first-level processing and supply it directly as input to the second-level processing sequence, preserving the computational work already performed and reducing the total processing time required to produce a match result.

In some embodiments, the system is configured to extract one or more page characteristics from the normalized image during the second-level processing sequence. In some embodiments, the page characteristics extracted during the second-level processing sequence represent a richer and more discriminating description of the captured page than the lower-resolution fingerprint generated during first-level processing, enabling the system to distinguish between entries in the characteristic database that could not be differentiated at the first processing level.

For example, in some embodiments, the system is configured to evaluate the amount of whitespace present on the page to generate a whitespace distribution characteristic for use as a page identifier. In some embodiments, the system is configured to evaluate the amount of text present on the page to generate a text density characteristic that distinguishes between different editions or formats of the same book. For example, in some embodiments, the system is configured to recognize the dense text layout characteristic of a study Bible edition and use the text density characteristic to distinguish it from a standard edition of the same text.

In some embodiments, the system is configured to analyze the font style and size present on the page to generate one or more typographic characteristics for use as page identifiers. In some embodiments, the system is configured to evaluate the number of lines per page to generate a line density characteristic that distinguishes between different editions or formats of the same book. In some embodiments, the system is configured to analyze the number of characters per line to generate a character density characteristic that further refines the distinction between candidate entries in the characteristic database.

In some embodiments, the system is configured to evaluate the page height-to-width ratio to generate a page dimension characteristic that identifies the physical dimensions of the book from which the page was captured. In some embodiments, the system is configured to analyze the surface finish type of the page, such as a glossy or matte surface finish, to generate a surface characteristic that further differentiates candidate entries in the characteristic database. For example, in some embodiments, the system is configured to detect a glossy surface finish characteristic on a captured page from an illustrated Bible edition and use this characteristic to narrow the candidate entries against which the captured page is compared.

In some embodiments, the system is configured to analyze the number of colors present on the page to generate a color distribution characteristic that distinguishes between black-and-white and multi-color editions of the same book. In some embodiments, the system is configured to analyze physical page attributes, such as a page corner geometry characteristic (e.g., rounded corners) or an edge finish characteristic (e.g., gold leaf), to generate one or more physical attribute characteristics that distinguish the captured page from entries in the characteristic database that do not share the same physical attributes. For example, in some embodiments, the system is configured to detect an edge finish characteristic on a captured scripture page and use this physical attribute characteristic to reduce the set of candidate entries in the characteristic database to those associated with editions known to include the same edge finish characteristic.

In some embodiments, the system is configured to analyze the presence of non-text visual elements on the page, such as decorative border elements (e.g., ornate borders), illustration elements (e.g., embedded artwork or figures), or other distinguishing visual features, to generate one or more non-text pattern characteristics. In some embodiments, the system is configured to analyze the spatial distribution of text elements on the page, including the locations of structural text elements such as section headers, subheaders, verse numbers, chapter markers, and page number locations, to generate one or more text location characteristics that improve the accuracy of page recognition. For example, in some embodiments, the system is configured to detect the location of chapter header elements and verse number elements on a captured scripture page and generate text location characteristics that encode the spatial positions of these elements relative to the overall page layout, enabling the system to distinguish between pages from different sections of the same book.

In some embodiments, the system is configured to abstract the extracted page characteristics into a vector representation that captures the relative positions, proportions, and distributions of the extracted features across the page. In some embodiments, the vector representation is configured to encode the extracted page characteristics in a format suitable for efficient comparison against corresponding vector representations stored in the characteristic database, enabling the system to perform a vector-based search across a large number of candidate entries without requiring full-resolution image comparison or text-level analysis. In a non-limiting example, the system is configured to convert the extracted page characteristics of a captured Bible page, including its text density characteristic, whitespace distribution characteristic, and text location characteristics, into a vector representation that encodes the relative positions of text blocks, whitespace regions, and structural elements for use in a vector-based search of the characteristic database.

In some embodiments, the system is configured to execute a vector-based search comparing the vector representation against corresponding entries stored in the characteristic database. In some embodiments, the system is configured to use the vector-based search to identify one or more candidate entries whose stored vector representations most closely correspond to the vector representation derived from the captured page. In some embodiments, the system is configured to apply fuzzy matching techniques during the vector-based search to account for minor variations in extracted page characteristics caused by environmental factors, capture conditions, or physical wear on the book page, ensuring that such variations do not prevent the identification of the correct candidate entry. For example, in some embodiments, the system is configured to apply tolerance thresholds during the vector-based search to accommodate variations in the whitespace distribution characteristic and text density characteristic of a captured scripture page that may result from the page curvature of a bound book or the angle of capture by the user's device.

In some embodiments, the system is configured to evaluate the result of the vector-based search to determine an updated confidence level for a potential match between the captured page and one or more candidate entries in the characteristic database. In some embodiments, the updated confidence level is derived from a combination of the similarity score produced by the vector-based search and the confidence level carried forward from the first-level processing sequence, enabling the system to incorporate all prior processing results into the determination of whether a sufficient match has been identified. In some embodiments, the system is configured to determine whether the updated confidence level satisfies a second threshold sufficient to identify at least one of the book and the page from which the captured image was derived. In some embodiments, the second threshold represents a higher confidence requirement than the first threshold, reflecting the greater discriminating power of the page characteristics extracted during the second-level processing sequence relative to the low-resolution fingerprint generated during first-level processing. For example, in some embodiments, the system is configured to evaluate whether the updated confidence level produced by comparing the vector representation of a captured scripture page against the characteristic database is sufficient to identify the corresponding book, edition, and page without escalating to the more computationally intensive processing of the third-level processing sequence.

In some embodiments, the system is configured to output a match result identifying at least one of the book and the page corresponding to the captured image when the updated confidence level satisfies the second threshold. In some embodiments, the match result generated upon satisfaction of the second threshold is configured to include metadata associated with the matched entry in the characteristic database, including at least one of the book title, edition identifier, page number, and version information. For example, in some embodiments, the system is configured to output a match result identifying the specific edition and page of a Bible when the updated confidence level produced by the vector-based search satisfies the second threshold, enabling downstream processing to proceed using the identified match without requiring further escalation.

In some embodiments, the system is configured to generate a second escalation signal when the updated confidence level does not satisfy the second threshold. In some embodiments, the second escalation signal is configured to initiate a third-level processing sequence that applies optical character recognition, text-level analysis, and additional stylistic processing to the captured image using the greatest computational resources of the three processing levels. In a non-limiting example, the system is configured to generate a second escalation signal when a captured image of a Bible page that is visually similar to multiple entries in the characteristic database produces an updated confidence level that falls below the second threshold after the vector-based search, indicating that the page characteristics extracted during the second-level processing sequence were insufficient to distinguish the captured page from the remaining candidate entries and that text-level analysis is required to confirm the match.

In some embodiments, the system is configured to store at least the vector representation, the extracted page characteristics, and the updated confidence level upon completion of the second-level processing sequence, regardless of whether a match result is output or a second escalation signal is generated. In some embodiments, the stored second-level processing results are configured to be retrieved and used as input for the third-level processing sequence when the second escalation signal has been generated, avoiding redundant re-execution of the feature extraction and vector abstraction steps performed during the second-level processing sequence and preserving the cumulative computational work performed across all prior processing levels. For example, in some embodiments, the system is configured to store the vector representation and extracted page characteristics derived from a captured scripture page alongside the normalized image and numerical identifier stored during the first-level processing sequence, enabling the third-level processing sequence to access all prior processing outputs through the session identifier assigned at the time the raw input file was created.

In some embodiments, the system is configured to execute a third-level processing sequence upon receiving a second escalation signal generated during the second-level processing sequence. In some embodiments, the system is configured to treat the second escalation signal as a discrete trigger that initiates the third-level processing sequence automatically and without requiring additional input from the user, enabling the system to continue processing the captured image transparently within the same user interaction session. In some embodiments, the third-level processing sequence is configured to apply the most computationally intensive analysis of the three processing levels, reserving text-level recognition and detailed stylistic analysis for only those captured images whose page characteristics were insufficient to produce a confident match result during the first-level and second-level processing sequences. For example, in some embodiments, the system is configured to automatically initiate the third-level processing sequence when a captured image of a physical book page, such as a Bible page that shares similar layout characteristics with multiple entries in the characteristic database, produces an updated confidence level during second-level processing that falls below the second threshold, indicating that the vector representation of extracted page characteristics alone was insufficient to distinguish the captured page from the remaining candidate entries.

In some embodiments, the system is configured to retrieve the normalized image, the numerical identifier, the extracted page characteristics, the vector representation, and the updated confidence level stored during the first-level and second-level processing sequences upon receiving the second escalation signal. In some embodiments, the system is configured to use all retrieved prior processing results as the starting point for the third-level processing sequence, avoiding redundant re-execution of the corrective normalization process, the low-resolution fingerprint generation, and the page characteristic extraction steps performed during the prior processing levels. In a non-limiting example, the system is configured to retrieve all prior processing outputs associated with the session identifier assigned at the time the raw input file was created, enabling the third-level processing sequence to access the cumulative results of all prior processing levels through a single retrieval operation without reprocessing the captured image from its original state.

In some embodiments, the system is configured to execute optical character recognition on the normalized image to extract text content from the captured page. In some embodiments, the optical character recognition process is configured to identify and extract individual characters, words, and text structures present on the normalized image, generating a text content output that represents the readable content of the captured page in a machine-processable format. In some embodiments, the system is configured to detect the language of the extracted text content to further narrow the set of candidate entries in the characteristic database against which the captured page is compared. For example, in some embodiments, the system is configured to execute optical character recognition on a normalized image of a scripture page to extract the text of a passage from the Book of Genesis and identify the language of the extracted text as English, using the language characteristic to constrain the candidate entries in the characteristic database to those associated with English-language editions of the corresponding text.

In some embodiments, the system is configured to compare the extracted text content to one or more clean reference files stored in the characteristic database to evaluate the degree of correspondence between the captured page and stored reference entries. In some embodiments, the clean reference files are configured to represent print-ready or otherwise pre-processed versions of book pages that provide an authoritative reference against which the extracted text content of the captured page can be evaluated. In some embodiments, the system is configured to use the degree of correspondence between the extracted text content and the clean reference files to generate a text match score that contributes to the determination of the final confidence level. For example, in some embodiments, the system is configured to compare the text content extracted from a captured scripture page against clean reference files derived from publisher-supplied print-ready files of multiple Bible editions stored in the characteristic database, using the resulting text match score to distinguish between editions whose page characteristics were insufficiently different to produce a confident match result during second-level processing.

In some embodiments, the system is configured to execute a detailed stylistic analysis on the normalized image during the third-level processing sequence. In some embodiments, the detailed stylistic analysis is configured to evaluate one or more of typographic characteristics, decorative element characteristics, layout stylization characteristics, and illustration content characteristics present on the normalized image, as non-limiting examples, generating a detailed stylistic profile of the captured page that supplements the page characteristics extracted during the second-level processing sequence. In some embodiments, the detailed stylistic analysis is configured to analyze characteristics that require higher-resolution feature inspection than was applied during the second-level processing sequence, enabling the system to detect fine-grained distinguishing features that were not captured by the vector representation generated during prior processing. For example, in some embodiments, the system is configured to execute a detailed stylistic analysis on a normalized image of a Bible page to detect the presence of ornate border elements and decorative typographic features characteristic of a specific deluxe edition, generating a detailed stylistic profile that distinguishes the captured page from standard editions of the same text whose page characteristics produced similar vector representations during second-level processing.

In some embodiments, the system is configured to generate one or more advanced representations from the extracted text content and the normalized image during the third-level processing sequence. In some embodiments, the system is configured to generate a text embedding vector derived from the text content extracted by the optical character recognition process. In some embodiments, the text embedding vector is configured to encode the semantic and structural characteristics of the extracted text content in a compact numerical format that captures the meaning and arrangement of the text independently of its visual presentation on the page, enabling the system to identify matches between pages whose text content corresponds even when their visual characteristics differ. For example, in some embodiments, the system is configured to generate a text embedding vector from the scripture text extracted from a captured page of the Book of Psalms and compare it against text embedding vectors stored in the characteristic database to identify the specific psalm and verse present on the captured page.

In some embodiments, the system is configured to generate a global visual embedding that summarizes, as non-limiting examples, the page-level layout, typography, and whitespace structure of the normalized image. In some embodiments, the global visual embedding is configured to encode the overall visual organization of the page in a compact representation that captures relationships between text blocks, whitespace regions, and visual elements at a higher level of abstraction than the pixel-level numerical identifier generated during first-level processing or the feature-level vector representation generated during second-level processing. As a non-limiting example, in some embodiments, the system is configured to generate a global visual embedding from a normalized image of a scripture page that encodes the two-column layout, the relative proportions of text and whitespace, and the position of structural elements such as chapter headers and verse numbers, enabling the system to use the global visual embedding to rapidly shortlist candidate entries in the characteristic database before applying more targeted comparisons.

In some embodiments, the system is configured to generate a set of local feature descriptors associated with keypoints distributed over the normalized page image. In some embodiments, a keypoint includes a specific location within the normalized page image that has been algorithmically identified as having distinctive and stable visual characteristics, such that the same location can be reliably detected across multiple captured images of the same page even when those images differ in capture angle, lighting conditions, or scale. In some embodiments, keypoint locations on a page image may correspond to visually distinctive positions such as the corners of text blocks, the boundaries between whitespace regions and text regions, the edges of illustrations or decorative elements, the junctions of layout structures, or other locations on the page whose local visual characteristics are sufficiently unique to enable consistent detection and comparison. In some embodiments, the local feature descriptors are configured to encode the visual characteristics of the region surrounding each keypoint in a compact numerical format, enabling the system to perform robust matching between the captured page and candidate entries in the characteristic database under conditions of perspective variation, partial occlusion, and user-added markings.

In some embodiments, the system is configured to apply a learned model to detect the keypoints and concurrently generate a compact descriptor for each detected keypoint, enabling efficient comparison of the local feature descriptors against corresponding descriptors stored in the characteristic database using descriptor-space nearest-neighbor comparisons with geometric consistency checks. For example, in some embodiments, the system is configured to detect keypoints at the corners of text blocks, the boundaries of whitespace regions, and the edges of decorative elements on a captured scripture page, generate a local feature descriptor encoding the visual characteristics of the region surrounding each detected keypoint, and use the resulting set of local feature descriptors to confirm the identity of the captured page by matching its fine-grained visual features against the corresponding entry in the characteristic database.

In some embodiments, the system is configured to execute a spline analysis on the normalized image to identify inflection points and patterns within the captured page. In some embodiments, the spline analysis is configured to characterize the structural contours and spatial patterns of the page content in a format that complements the text embedding vector, the global visual embedding, and the local feature descriptors, providing an additional basis for distinguishing between candidate entries in the characteristic database that share similar characteristics at all other levels of analysis. For example, in some embodiments, the system is configured to execute a spline analysis on a normalized image of a scripture page to identify inflection points corresponding to the transitions between text blocks and whitespace regions, using the resulting spline analysis output to further refine the distinction between candidate entries whose global visual embeddings and local feature descriptors produced similar match scores.

In some embodiments, the system is configured to combine the one or more advanced representations generated during the third-level processing sequence with the numerical identifier and the vector representation carried forward from the first-level and second-level processing sequences to produce a composite match input. In some embodiments, the composite match input is configured to represent the most comprehensive description of the captured page available to the system at the conclusion of the third-level processing sequence, incorporating all processing outputs generated across the three processing levels into a unified input for the final matching analysis. In a non-limiting example, the system is configured to combine the text embedding vector, the global visual embedding, the local feature descriptors, and the spline analysis output generated during third-level processing with the numerical identifier and vector representation carried forward from prior processing levels to produce a composite match input that encodes the captured page at the pixel level, the feature level, the layout level, and the text content level simultaneously.

In some embodiments, the system is configured to compare the composite match input against entries in the characteristic database using the one or more advanced representations generated during the third-level processing sequence. In some embodiments, the system is configured to use the global visual embedding to rapidly shortlist candidate entries and to use the local feature descriptors to produce a refined match score via descriptor-space nearest-neighbor comparisons with geometric consistency checks. In some embodiments, the system is configured to further refine the match score using the text embedding vector and the text match score generated by comparing the extracted text content against the clean reference files, enabling the system to resolve distinctions between candidate entries that could not be determined using visual characteristics alone. For example, in some embodiments, the system is configured to compare the composite match input derived from a captured scripture page against entries in the characteristic database by first applying the global visual embedding to identify a shortlist of candidate entries, then applying the local feature descriptors to produce a refined match score for each candidate entry, and then applying the text embedding vector and text match score to confirm the identity of the correct entry among the remaining candidates.

In some embodiments, the system is configured to determine a final confidence level based on the comparison of the composite match input against the characteristic database. In some embodiments, the final confidence level is derived from the combined outputs of all comparisons performed during the third-level processing sequence, incorporating the text match score, the global visual embedding similarity score, the local feature descriptor match score, and the spline analysis match score into a unified confidence determination. In some embodiments, the system is configured to determine whether the final confidence level satisfies a third threshold sufficient to confirm the identification of at least one of the book and the page from which the captured image was derived. In some embodiments, the third threshold represents the highest confidence requirement of the three processing levels, reflecting the expectation that the composite match input produced by the third-level processing sequence provides sufficient discriminating power to confirm the identity of the captured page in all but the most ambiguous cases. For example, in some embodiments, the system is configured to evaluate whether the final confidence level produced by comparing the composite match input of a captured scripture page against the characteristic database is sufficient to confirm the identity of the specific edition, version, and page of the Bible from which the captured image was derived.

In some embodiments, the system is configured to output a confirmed match result identifying at least the book, the edition, and the page corresponding to the captured image when the final confidence level satisfies the third threshold and a single candidate entry in the characteristic database is identified as the matching entry. In some embodiments, the confirmed match result is configured to include metadata associated with the matched entry in the characteristic database, including at least one of the book title, edition identifier, version information, page number, and source reference information. For example, in some embodiments, the system is configured to output a confirmed match result identifying the specific translation, edition, and page of a Bible when the final confidence level produced by the composite match input comparison satisfies the third threshold, enabling all downstream processing sequences, such as those discussed supra, to proceed using the confirmed match result and its associated metadata.

In some embodiments, the system is configured to identify one or more candidate match entries from the characteristic database when multiple entries satisfy the third threshold, indicating that the composite match input was insufficient to uniquely identify a single matching entry. In some embodiments, the system is configured to present the identified candidate match entries to the user via a graphical user interface when multiple entries satisfy the third threshold, enabling the user to select the correct match from among the presented candidates. In some embodiments, the graphical user interface is configured to display identifying information associated with each candidate match entry, such as the book title, edition, version, and distinguishing characteristics of each candidate, to enable the user to make an informed selection. For example, in some embodiments, the system is configured to present a user with a list of candidate match entries via a graphical user interface when a captured scripture page produces a final confidence level that satisfies the third threshold for multiple Bible editions stored in the characteristic database, displaying the title, translation, and edition information for each candidate to enable the user to identify and select the correct match.

In some embodiments, the system is configured to attribute the confirmed match result to the user upon output of the confirmed match result, storing the confirmed match result in a user profile associated with the user identifier assigned at the time the raw input file was created. In some embodiments, the system is configured to use the attributed match result to enable the system to recognize the matched book during subsequent interactions with the same user, enabling the system to prioritize the matched book and edition as a candidate during future matching operations for the same user. For example, in some embodiments, the system is configured to attribute a confirmed match result identifying a specific edition of a Bible to a user profile, enabling the system to prioritize that edition as a candidate during subsequent matching operations when the same user captures additional images of pages from the same book.

In some embodiments, the system is configured to store the confirmed match result and all associated metadata upon completion of the third-level processing sequence, regardless of whether the confirmed match result was produced by the system or selected by the user from a list of candidate match entries. In some embodiments, the stored confirmed match result and associated metadata are configured to be available for use by downstream processing sequences, enabling the system to apply the identified book, edition, and page information to one or more additional system functions without requiring the user to re-initiate the matching process. In a non-limiting example, the system is configured to store the confirmed match result identifying the specific edition and page of a Bible alongside all processing outputs generated across the first-level, second-level, and third-level processing sequences, associating the complete processing record with the session identifier and user identifier assigned at the time the raw input file was created and making the confirmed match result available for use by downstream processing sequences including annotation extraction, content synchronization, and user engagement features.

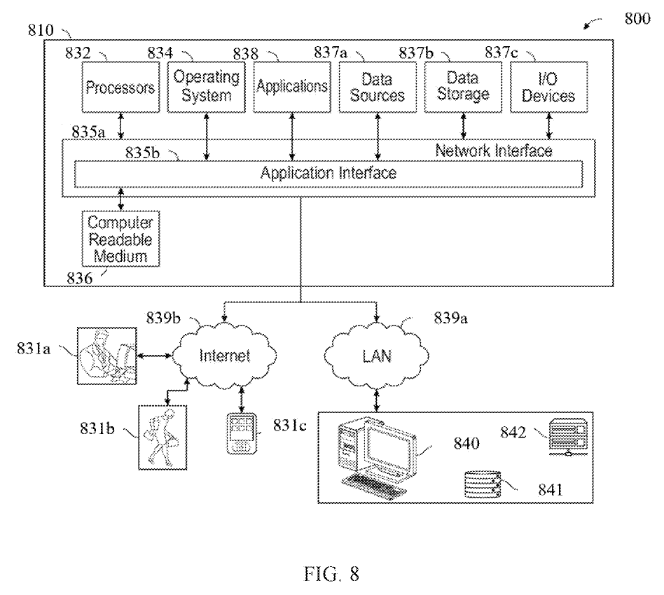

FIG. 8 illustrates a computer system 810 enabling or comprising the systems and methods in accordance with some embodiments. In some embodiments, the computer system 810 is configured to operate and/or process computer-executable code of one or more software modules of the aforementioned system and method. Further, in some embodiments, the computer system 810 is configured to operate and/or display information within one or more graphical user interfaces (e.g., HMIs) integrated with or coupled to the system.

In some embodiments, the computer system 810 comprises one or more processors 832. In some embodiments, at least one processor 832 resides in, or is coupled to, one or more servers. In some embodiments, the computer system 810 includes a network interface 835a and an application interface 835b coupled to the least one processor 832 capable of processing at least one operating system 834. Further, in some embodiments, the interfaces 835a, 835b coupled to at least one processor 832 are configured to process one or more of the software modules (e.g., such as enterprise applications 838). In some embodiments, the software application modules 838 includes server-based software. In some embodiments, the software application modules 838 are configured to host at least one user account and/or at least one client account, and/or are configured to operate to transfer data between one or more of these accounts using one or more processors 832.

With the above embodiments in mind, it is understood that the system is configured to execute various computer-implemented program steps involving data stored on one or more non-transitory computer media according to some embodiments. In some embodiments, the above-described databases and models described throughout this disclosure are configured to store analytical models and other data on non-transitory computer-readable storage media within the computer system 810 and on computer-readable storage media coupled to the computer system 810 according to some embodiments. In addition, in some embodiments, the above-described applications of the system are stored on computer-readable storage media within the computer system 810 and on computer-readable storage media coupled to the computer system 810. In some embodiments, these operations are those requiring physical manipulation of structures including electrons, electrical charges, transistors, amplifiers, receivers, transmitters, and/or any conventional computer hardware in order to transform an electrical input into a different output. In some embodiments, these structures include one or more of electrical, electromagnetic, magnetic, optical, and/or magneto-optical signals capable of being stored, transferred, combined, compared, and otherwise manipulated. In some embodiments, the computer system 810 comprises at least one computer readable medium 836 coupled to at least one of at least one data source 837a, at least one data storage 837b, and/or at least one input/output 837c. In some embodiments, the computer system 810 is embodied as computer readable code on a computer readable medium 836. In some embodiments, the computer readable medium 836 includes any data storage that stores data, which is configured to thereafter be read by a computer (such as computer 840). In some embodiments, the non-transitory computer readable medium 836 includes any physical or material medium that is used to tangibly store the desired information, steps, and/or instructions and which is configured to be accessed by a computer 840 or processor 832. In some embodiments, the non-transitory computer readable medium 836 includes hard drives, network attached storage (NAS), read-only memory, random-access memory, FLASH-based memory, CD-ROMs, CD-Rs, CD-RWs, DVDs, magnetic tapes, and/or other optical and non-optical data storage. In some embodiments, various other forms of computer-readable media 836 are configured to transmit or carry instructions to one or more remote computers 840 and/or at least one user 831, including a router, private or public network, or other transmission or channel, both wired and wireless. In some embodiments, the software application modules 838 are configured to send and receive data from a database (e.g., from a computer readable medium 836 including data sources 837a and data storage 837b that comprises a database), and data is configured to be received by the software application modules 838 from at least one other source. In some embodiments, at least one of the software application modules 838 are configured to be implemented by the computer system 810 to output data to at least one user 831 via at least one graphical user interface rendered on at least one digital display.

In some embodiments, the one or more non-transitory computer readable 836 media are distributed over a conventional computer network via the network interface 835a where some embodiments stored the non-transitory computer readable media are stored and executed in a distributed fashion. For example, in some embodiments, one or more components of the computer system 810 are configured to send and/or receive data through a local area network (“LAN”) 839a and/or an internet coupled network 839b (e.g., such as a wireless internet). In some embodiments, the networks 839a, 839b include one or more wide area networks (“WAN”), direct connections (e.g., through a universal serial bus port), or other forms of computer-readable media 836, and/or any combination thereof.

In some embodiments, components of the networks 839a, 839b include any number of personal computers 840 which include for example desktop computers, laptop computers, and/or any fixed, generally non-mobile internet appliances coupled through the LAN 839a. For example, some embodiments include one or more personal computers 840, databases 841, and/or servers 842 coupled through the LAN 839a that are configured for use by any type of user including an administrator. Some embodiments include one or more personal computers 840 coupled through network 839b. In some embodiments, one or more components of the computer system 810 are configured to send or receive data through an internet network (e.g., such as network 839b). For example, some embodiments include at least one user 831a, 831b, coupled wirelessly and accessing one or more software modules of the system including at least one enterprise application 838 via an input and output (“I/O”) 837c. In some embodiments, the computer system 810 is configured to enable at least one user 831a, 831b, to be coupled to access enterprise applications 838 via an I/O 837c through LAN 839a. In some embodiments, the user 831 includes a user 831a coupled to the computer system 810 using a desktop computer, and/or laptop computers, or any fixed, generally non-mobile internet appliances coupled through the internet 839b. In some embodiments, the user includes a mobile user 831b coupled to the computer system 810. In some embodiments, the user 831b connects using any mobile computing 831c to wireless coupled to the computer system 810, including, but not limited to, one or more personal digital assistants, at least one cellular phone, at least one mobile phone, at least one smart phone, at least one pager, at least one digital tablet, and/or at least one fixed or mobile internet appliances.

In some embodiments, the system is configured to leverage artificial intelligence (AI) techniques, including machine learning (ML) models, to analyze and process scanned book pages for accurate identification and matching. In some embodiments, the system is configured to utilize specific ML architectures, such as convolutional neural networks (CNNs), recurrent neural networks (RNNs), autoencoders, or support vector machines (SVMs), to extract and analyze features from scanned images. For example, the system is configured to use a CNN to detect the unique layout of scripture pages, such as the two-column format of the Book of Psalms, by identifying patterns in text alignment, whitespace proportions, and headers.

In some embodiments, the system is configured to implement AI models that include one or more of computer vision, feature vector analysis, decision trees, boosting, nearest neighbor algorithms, Naive Bayes, bagging, random forests, logistic regression, and others, to enhance the accuracy of page recognition. In a non-limiting example, the system is configured to apply an XGBoost algorithm for classification tasks, such as distinguishing between scanned pages of different Bible editions based on stylistic traits like font type, page dimensions, or decorative elements.

In some embodiments, the system is configured to execute AI algorithms in a time-based manner, where collected data is segmented into specific time intervals for analysis. For example, the system is configured to use a Bayesian model to analyze user interactions with scanned pages of the Gospel of Matthew over a 24-hour period, identifying patterns in user engagement, such as repeated scans of specific verses or chapters.

In some embodiments, the system is configured to implement neural network techniques optimized for the recognition and matching of scanned book pages. These techniques may include feedforward neural networks, radial basis function networks, recurrent neural networks, convolutional networks (e.g., U-net), or other architectures configured for image processing, in accordance with some embodiments. For example, the system is configured to use a U-net convolutional network to segment scanned images into regions, identifying text blocks, illustrations, and whitespace to create a detailed fingerprint of the page.

In some embodiments, the system is configured to execute a neural network implementation as follows: defining the architecture for the recognition framework, transferring input data (e.g., scanned page characteristics) to the neural network model, incrementally training the model using labeled data, determining accuracy over specific timesteps, applying the trained model to process newly received input data, and optionally continuing to train the model periodically. For example, the system is configured to train a neural network to recognize ornate borders and gold-leaf edges of scripture pages in a deluxe Bible edition and apply the trained model to identify similar features in future scans.

In some embodiments, the trained AI model is configured to execute a neural network by its topology, activation functions, and connection weights. For example, the topology may define the arrangement of nodes and connections, while activation functions, such as sigmoid, hyperbolic tangent, or ReLU (Rectified Linear Unit), determine the threshold at which nodes are activated. In some embodiments, the system is configured to use aggregation functions, such as summing or multiplying input signals, to combine data before applying it to the activation function. For example, the system is configured to use these neural network parameters to refine its ability to distinguish between scanned pages of the Book of Genesis from different translations, ensuring accurate matching based on layout and stylistic traits.

In some embodiments, the system is configured to incorporate bias values into the neural network model to adjust the likelihood of node activation, improving the model’s ability to handle variations in scanned pages. For example, the system is configured to account for environmental factors, such as lighting or page curvature, by using bias values to ensure consistent recognition of scripture pages, even under challenging scanning conditions.

The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements and advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

The specification herein provides references to specific examples, such as “Bible,” “Book of Psalms,” “Gospel of Matthew,” and other named texts, as illustrative examples of the system’s functionality. These references are intended to clarify the scope and operation of the system in the context of specific use cases. However, when defining the metes and bounds of the system, these specific references can be replaced by generic terms, such as “book,” “document,” “text,” or “content,” to encompass broader applications of the system.

For example, references to the “Book of Psalms” may be replaced by “a book” and references to “Bible pages” may be replaced by “pages from a religious text” or “pages from any printed book.” Similarly, references to “scripture passages” may be replaced by “passages” or “text” to include non-religious works, such as academic texts, novels, or instructional manuals.

Any text in the drawings is part of the system’s disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant’s own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations thereof (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function according to some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the system are useful machine operations. The system also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the system can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods that can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable, and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the system has been described above in connection with particular embodiments and examples, the system is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the system are set forth in the following claims.

We claim:

1. A system comprising one or more computers each comprising one or more processors and one or more non-transitory computer readable media, the one or more non-transitory computer readable media comprising program instructions stored thereon that when executed cause the one or more computers to:
execute, by the one or more processors, a corrective normalization process on a captured image of a page received from a user device to generate a normalized output;
generate, by the one or more processors, a representation of the normalized output;
compare, by the one or more processors, the representation against a characteristic database to determine a confidence level for a potential match between the captured image and an entry in the characteristic database;
output, by the one or more processors, a match result identifying at least one of a book and a page corresponding to the captured image when the confidence level satisfies a first threshold; and
generate, by the one or more processors, an escalation signal to initiate a subsequent processing operation on the normalized output when the confidence level does not satisfy the first threshold.

2. The system of claim 1, wherein the one or more non-transitory computer readable media further comprise program instructions stored thereon that when executed cause the one or more computers to:
downscale, by the one or more processors, the normalized output into a lower-resolution representation;
extract, by the one or more processors, pixel data from the lower-resolution representation to generate a numerical identifier; and
compare, by the one or more processors, the numerical identifier against the characteristic database to determine the confidence level relative to the first threshold.

3. The system of claim 2,
wherein downscaling the normalized output further comprises extracting pixel data by overlaying a grid to the lower-resolution representation dividing the lower-resolution representation into a plurality of regions.

4. The system of claim 3,
wherein generating the numerical identifier comprises:
sampling a plurality of pixels within each of the plurality of regions; and
extracting a plurality of RGB values from the sampled plurality of pixels.

5. The system of claim 2,
wherein the escalation signal comprises a first escalation signal configured to initiate a second-level processing operation on the normalized output when the confidence level does not satisfy the first threshold.

6. The system of claim 5,
wherein the one or more non-transitory computer readable media further comprise program instructions stored thereon that when executed cause the one or more computers to:
store, upon generation of the first escalation signal, the normalized output, the numerical identifier, and the confidence level in association with a session identifier and a user identifier for retrieval during the second-level processing operation.

7. The system of claim 2,
wherein the one or more non-transitory computer readable media further comprise program instructions stored thereon that when executed cause the one or more computers to:
extract, by the one or more processors, upon receiving a first escalation signal, one or more page characteristics from the normalized output;
transform, by the one or more processors, the one or more page characteristics into a vector representation; and
compare, by the one or more processors, the vector representation against the characteristic database to determine an updated confidence level relative to a second threshold.

8. The system of claim 7,
wherein the one or more page characteristics comprise at least one of a structural characteristic, a typographic characteristic, a physical attribute characteristic, and a non-text visual element characteristic.

9. The system of claim 8,
wherein at least one of the structural characteristics comprises at least one of a whitespace distribution characteristic, a text density characteristic, a font characteristic, a line density characteristic, a character density characteristic, and a page dimension characteristic.

10. The system of claim 8,
wherein at least one of the physical attribute characteristics comprises at least one of a surface finish characteristic, a color distribution characteristic, a page corner geometry characteristic, an edge finish characteristic, a decorative border element characteristic, and an illustration element characteristic.

11. The system of claim 7,
wherein transforming the one or more page characteristics into the vector representation further comprises encoding relative positions, proportions, and distributions of the one or more page characteristics across the normalized output in a format suitable for vector-based comparison against the characteristic database.

12. The system of claim 11,
wherein the one or more non-transitory computer readable media further comprise program instructions stored thereon that when executed cause the one or more computers to:
execute, by the one or more processors, a vector-based search comparing the vector representation against corresponding entries in the characteristic database; and
apply, by the one or more processors, a tolerance threshold during the vector-based search to account for variations in the one or more page characteristics caused by at least one of environmental factors, capture conditions, and physical wear on the page.

13. The system of claim 12, wherein the one or more non-transitory computer readable media further comprise program instructions stored thereon that when executed cause the one or more computers to:
generate, by the one or more processors, a second escalation signal to initiate a third-level processing operation on the normalized output when the updated confidence level does not satisfy the second threshold; and
store, by the one or more processors, the vector representation, the one or more page characteristics, and the updated confidence level for retrieval during the third-level processing operation.

14. The system of claim 7,
wherein the one or more non-transitory computer readable media further comprise program instructions stored thereon that when executed cause the one or more computers to:
execute, by the one or more processors, upon receiving a second escalation signal, optical character recognition on the normalized output to generate a text content output;
generate, by the one or more processors, one or more advanced representations from at least one of the text content output and the normalized output;
combine, by the one or more processors, the one or more advanced representations into a composite match input; and
compare, by the one or more processors, the composite match input against the characteristic database to determine a final confidence level relative to a third threshold.

15. The system of claim 14,
wherein generating the one or more advanced representations further comprises comparing the text content output against a reference file stored in the characteristic database to generate a text match score contributing to the final confidence level.

16. The system of claim 15,
wherein generating the one or more advanced representations further comprises generating a text embedding vector derived from the text content output encoding semantic and structural characteristics of the text content output in a format suitable for comparison against text embedding vectors stored in the characteristic database.

17. The system of claim 16,
wherein the one or more non-transitory computer readable media further comprise program instructions stored thereon that when executed cause the one or more computers to:
generate, by the one or more processors, a global visual embedding summarizing page-level layout, typography, and whitespace structure of the normalized output; and
use, by the one or more processors, the global visual embedding to generate one or more candidate entries in the characteristic database prior to applying a text embedding vector comparison.

18. The system of claim 14,
wherein the one or more non-transitory computer readable media further comprise program instructions stored thereon that when executed cause the one or more computers to:
generate, by the one or more processors, a set of local feature descriptors associated with a plurality of keypoints distributed over the normalized output;
wherein each keypoint of the plurality of keypoints includes an algorithmically identified location within the normalized output having distinctive and stable visual characteristics detectable across multiple captured images of a same page.

19. The system of claim 18,
wherein the one or more non-transitory computer readable media further comprise program instructions stored thereon that when executed cause the one or more computers to:
apply, by the one or more processors, an artificial intelligence model to detect the plurality of keypoints; and
generate a compact descriptor for each detected keypoint of the plurality of keypoints.

20. The system of claim 19,
wherein the one or more non-transitory computer readable media further comprise program instructions stored thereon that when executed cause the one or more computers to:
combine, by the one or more processors, a local feature descriptor match score derived from the set of local feature descriptors; and
present, by the one or more processors, one or more candidate match entries to the user via a graphical user interface when multiple entries in the characteristic database satisfy the third threshold.
